(19) United States
(12) Patent Application Publication
(10) Pub. No.: US 2011/0265478 A1
(43) Pub. Date: Nov. 3, 2011

(54) THERMOCHEMICAL THERMODYNAMICS CONTINUOUS CYCLE MACHINE

(76) Inventor: Ibrahim Cuhaci, Istanbul (TR)

(21) Appl. No.: 13/144,185

(22) PCT Filed: Jan. 5, 2010
(86) PCT No.: PCT/TR10/00001

§ 371 Date: Jul. 20, 2011

(30) Foreign Application Priority Data
Jan. 22, 2009 (TR) 2009/00450

(51) Int. Cl. F01K 23/06

(52) U.S. Cl. 60/670

(57) ABSTRACT

It is a thermodynamics machine carrying heat from T1 cold heat source to T2 hot heat source without using any energy operating contrary 0. law of thermodynamics or it is thermodynamics machine operating by using atmosphere heat using single heat source contrary 2. law of thermodynamics. Continuous cycle is combinated chemical reaction system in which A+B<->AB format homogeneous chemical reaction is controlled with having partner B component B+C→BC format mono direction chemical reaction. United chemical reaction system are continuous cycle, because heat of homogeneous reaction is bigger than direction reaction heat and this heat is used for the decomposition of mono direction reaction or never used heat for decomposition of mono direction reaction.

It is a thermodynamics machine operating contrary the main laws of thermodynamics, using a single heat source or carrying heat from T₁ cold source to T₂ hot source without using any energy. Machine is not available in the scientific literature but it is used homogeneous thermodynamics absorbtion cooling cyle, using water absorbant in spite of the fact that subject is general according to chemistry. Today in the available classic cycle; homogeneous or heterogeneous mixture of within the absorber are separated from each other by using outside heat source. Separation in this device are done by using chemical process technique and used chemical process technique uses less heat from carried heat or heat is not used according to process tecnique.

So occurring continuous the invention is a chemical process technique in which it does self-separation.

Three prototype devices have been projected according to using purpose and they use same theory. The devices have been classified according to being direct contrary law in spite of the fact that they are contrary complete laws of thermodynamics.

1—Alternative continuous thermic modifier
2—Direct continuous thermic modifier
3—Thermodynamics continuous cycle machine

First two devices are contrary 0. law of thermodynamics and they are thermic unstable and they have been called thermic modifier. Them purpose are to carry heat being continuously. Third device is contrary 2. law of thermodynamics and it is thermodynamics machine, using a single heat source, outputting mechanic. Its purpose is to translate the atmosphere heat to mechanic energy.

37 figures have been given within the scope of the project and explanations of the pictures are given below.

FIG.-1a Active controlled continuous cycle theoric thermic diode cycle flow diagram

FIG.-1b Active controlled continuous cycle real thermic diode cycle experiment device flow diagram

FIG.-1c Active controled continuous cycle thermic transistor cycle experiment device flow diagram

FIG.-2 Simple thermodynamics continuous cycle machine experiment device.

FIG.-3a Alternative thermic modifier mounting cross section drawings

FIG.-3b Alternative thermic modifier look from upside drawings.

FIG.-4 Alternative thermic modifier electro-mechanic valve control system

FIG.-5 Direct thermic modifier flow diagram

FIG.-6 Direct thermic modifier prototype absorber mounting cross section drawings

FIG.-7a Prototype absorber absorbing ejector detail cross section drawings

FIG.-7b Prototype absorber heat exchanger detail cross section drawings

FIG.-8 Direct thermic modifier separated part heat exchanger cross section drawings

FIG.-9 Thermodynamics continuous cycle machine flow diagram

FIG.-10 Changeable stroke synchronic engine mounting cross section drawings

FIG.-11 Half cog wheel-cog rail transferring mechanism shaft place plan

FIG.-12a Classic Gall chain

FIG.-12b Modified Gall chain

FIG.-12c Aplication plan of half cog wheel-cog rail mechanism for long stroke engine by using modified Gall chain

FIG.-13 Aplication plan of half cog wheel-cog rail mechanism for short stroke engine

FIG.-14a Prototype changeable stroke polyptropic steam engine working piston front cross section and look from upside detail drawings

FIG.-14b Prototype changeable stroke polyptropic steam engine working liner front cross section and look from upside detail drawings

FIG.-15a Prototype changeable stroke polyptropic steam engine having rotary piston port controled delivery-exhaust valve front cross section drawings

FIG.-15b Prototype changeable stroke steam engine port controlled delivery-exhaust valve rotary valve piston look from front and under drawings

FIG.-16 Prototype changeable stroke steam engine port controlled delivery-exhaust valve, valve cylinder front cross section and look from under drawings

FIG.-17 Prototype changeable stroke steam engine port controlled delivery-exhaust valve, valve cylinder core front cross section and look from under drawings

FIG.-18 Prototype changeable stroke steam engine port controlled delivery-exhaust valve, driving mechanism mounting plan

FIG.-19 Prototype changeable stroke steam engine, polyptropic liner and changeable stroke piston mounting cross section drawings

FIG.-20 Prototype changeable stroke steam engine, half cog wheel-cog rail mechanism shaft mounting cross section drawings

FIG.-21 Prototype solenoid engine-dynamo mounting cross section drawings

FIG.-22a Prototype solenoid engine-dynamo, induced solenoid coil for normal power look from front and upside

FIG.-22 b Prototype solenoid engine-dynamo, magnetic S-N pole core look from front and upside

FIG.-23 Prototype solenoid engine-dynamo, having circulation cooling induced solenoid coil for high power, front cross section drawings (it is not hatching)

FIG.-24 Prototype solenoid engine-dynamo, inductor coils mounting plan look from upside and occurred magnetic field lines

FIG.-25a Prototype solenoid engine-dynamo inductor unit up cover, front cross section and look from under detail drawings

FIG.-25b Prototype solenoid engine-dynamo, single part of coil core look from front and upside drawings

FIG.-26a Prototype solenoid engine-dynamo, laser photo-diode controlled rectifier unit, electronic circuit plan

FIG.-26b Laser photo-diode shaft modifier disc

Explanations of the used refferance numbers and signs on the drawings are given below

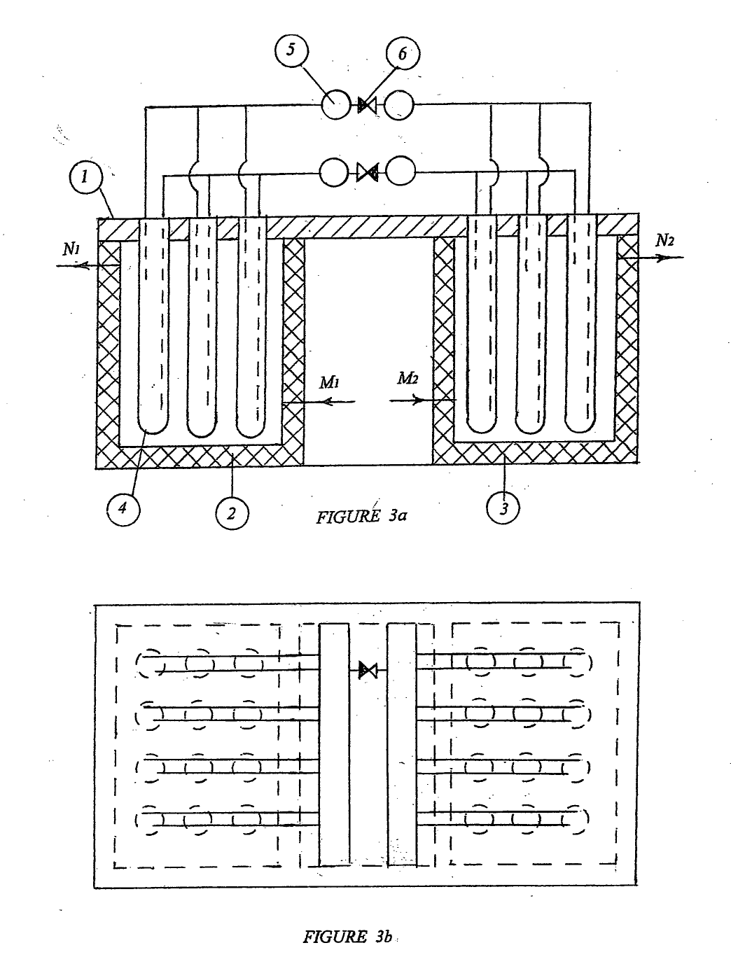

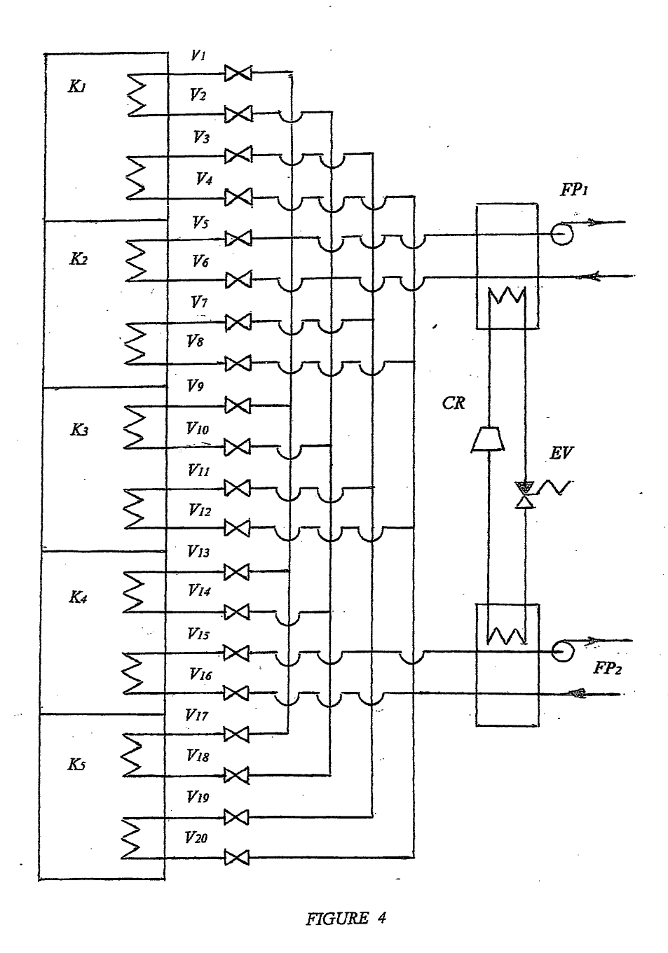

### FIG. 3a-3b-4

1—Alternative thermic modifier device cover
2—Alternative thermic modifier left heat battery container
3—Alternative thermic modifier right heat battery container
4—Alternative thermic modifier heat battery tube
5—Alternative thermic modifier heat battery manifold
6—Alternative thermic modifier flow control check valve

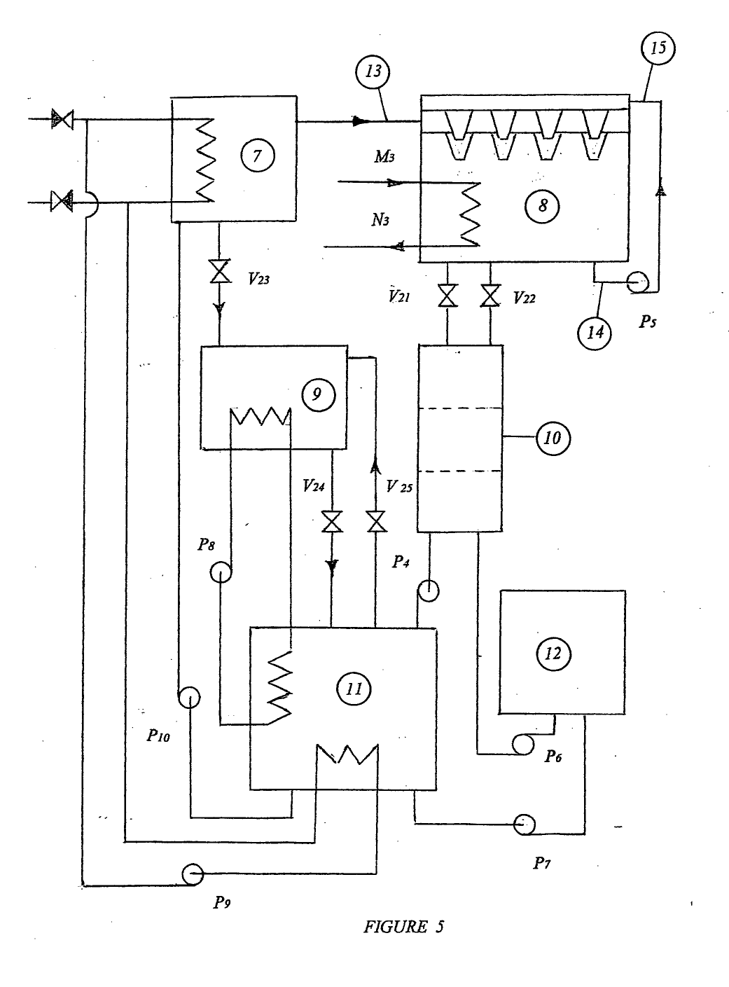

### FIG. 5-6-7a-7b-8

7—Evaparator (Boiler)
8—Prototype absorber (Condenser)
9—Evaparator feed tank
10—Direct thermic modifier separated part heat exchanger
11—Separator
12—Absorber feed tank
13—Absorber vapor inlet
14—Absorber absorbtion ejector feed solution outlet
15—Absorber absorbtion ejector feed solution inlet
16—Absorber lean solution inlet
17—Absorber rich solution outlet
18—Separated part heat exchanger pressure equilibrium line outlet
19—Body of absobtion ejector
20—Main nozzle
21—Absorbtion ejector feedback orifis
22—Diffuser
23—Guide nozzle

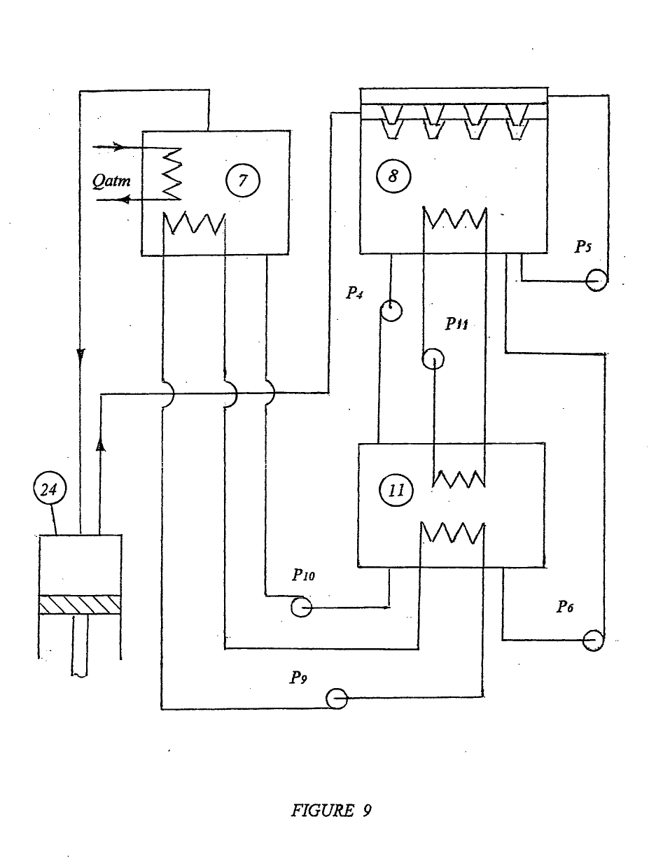

### FIG. 9-10-11-12a-12b-12c-13

24—Thermodynamics continuous cycle machine, changeable stroke polyptropic steam engine
25—Changeable stroke synchronic engine, working piston
26—Changeable stroke synchronic engine, working liner
27—Changeable stroke synchronic engine, engine cover
28—Changeable stroke synchronic engine, exhaust valve
29—Changeable stroke synchronic engine, having housing free piston rod
30—Half cog wheel-cog rail transfer mechanism, having cog rail piston rod
31—Half cog wheel-cog rail transfer mechanism, exhaust stroke a pair of half cog wheels
32—Half cog wheel-cograil transfer mechanism, working stroke a pair of half cog wheels
33—Half cog wheel-cog rail transfer mechanism, suction stroke a pair of half cog wheels
34—Half cog wheel-cog rail transfer mechanism, compression stroke a pair of half cog wheels
35—Half cog wheel-cog rail transfer mechanism, having cog rail compression piston rod
36—Changeable stroke synchronic engine, compression liner
37—Changeable stroke synchronic engine, compression piston
38—Changeable stroke synchronic engine, suction valve
39—Changeable stroke synchronic engine, slider transfer valve
40—Changeable stroke synchronic engine, fuel nozzle
41—Half cog wheel-cog rail mechanism, main shaft out-put transmission gear
42—Modified Gall chain, modification cylinder
43—Chain-cog wheel-cog rail mechanism, main-auxilary shaft transfer gear
44—Modified Gall chain
45—Idler wheel
46—Cog rail transmission gear

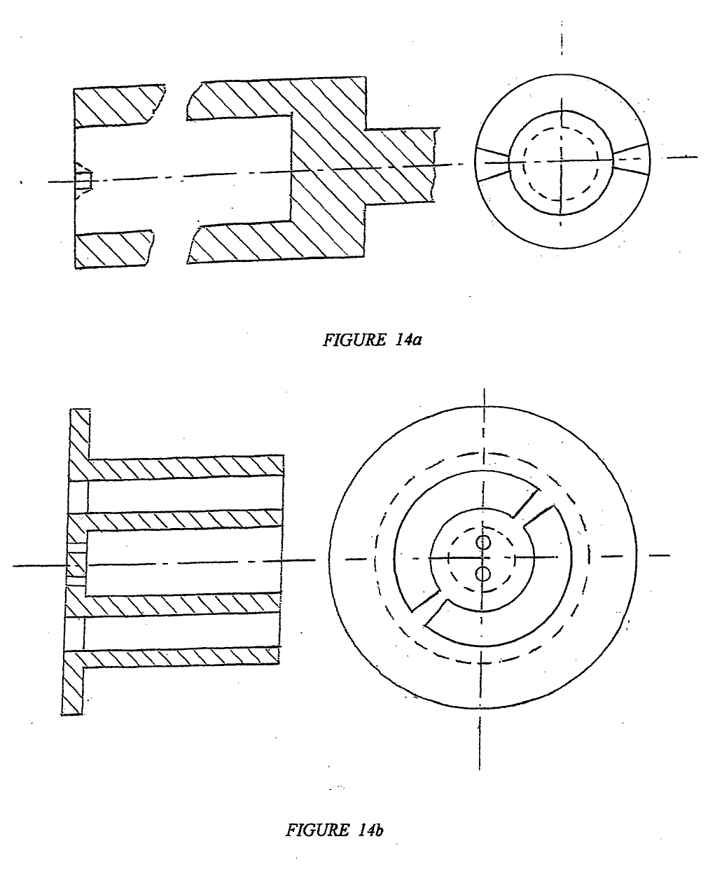

### FIG. 14a-14b-15a-15b-16-17-18-19-20

47—Port controlled having rotary piston delivery-exhaust valve, valve piston
48—Port controlled having rotary piston delivery-exhaust valve, valve liner
49—Port controlled having rotary piston delivery-exhaust valve, valve liner core
50—Delivery port
51—Exhaust port
52—Delivery canal
53—Port controlled having rotary piston delivery-exhaust valve-valve driving mechanism join pin hole
54—Port controlled having rotary piston delivery-exhaust valve, valve piston rod exit housing
55—Valve driving mechanism, exhaust port shutting cam
56—Thrust ball bearing
57—Ball bearing cover
58—Valve piston pusher bar
59—Lifting projection part for valve piston pusher bar
60—Pusher bar lifting cams
61—Delivery port opening pusher bar (turning pusher bar)
62—Spring
63—Delivery port opening cam
64—Plug
65—Delivery port turnning pusher bar body
66—Turnning projection part for valve piston pusher bar
67—Delivery port shuting cam
68—Steam engine polyptropic liner
69—Polyptropic liner heat transfer fluid inlet pipe
70—Stuffin-box packing type graphite liner-ring
71—Polyptropic liner bottom cover
72—Steam engine piston
73—Having housing cog rail
74—Polyptropic liner heat transfer fluid outlet pipe

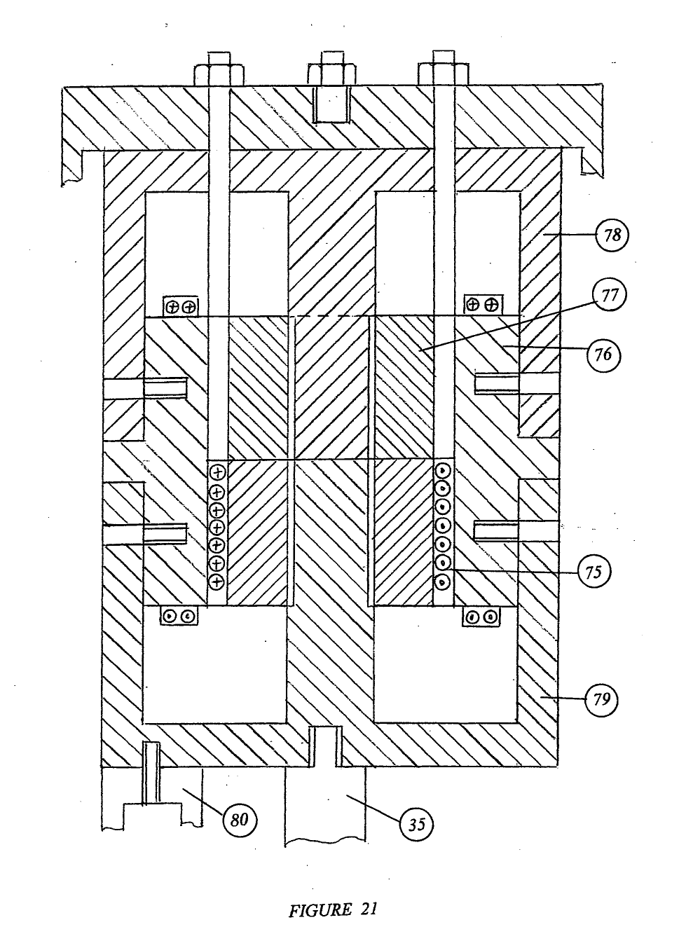

### FIG. 21-22a-22b-23-24-25a-25b-26a-26b

75—Induced solenoid coil
76—Inductor
77—S-N magnetic pole core
78—Inductor unit up cover
79—Inductor unit bottom cover
80—Inductor unit feeding auxilary solenoid coil
81—Induced solenoid helical coil former
82—Induced solenoid coil pipe wire
A—It is chemical substance, giving chemical homogeneous equilibrium react with B chemical substance but not giving chemical react with C chemical substance.
B—It is chemical substance, giving chemical homogeneous equilibrium react with A chemical substance but giving mono direction chemical react with C chemical substance on the under a k temparature.
C—It is chemical substance, giving mono direction chemical react with B chemical substance on the under a k temparature but not giving chemical react with A chemical substance.
K₁—Second step operating hot heat source
K₂—Main hot heat source
K₃—Feedback heat source
K₄—Atmosphere heat source
K₅—Cold heat source
FP₁—Alternative thermic modifier, left container heat transfer fluid circulation pump
FP₂—Alternative thermic modifier, right container heat transfer fluid circulation pump
P₁—Thermic diode fluid transfer pump
P₂—Thermic transistor hot source fluid transfer pump
P₃—Thermic transistor hot-cold source fluid transfer pump
P₄—Separated part heat exchanger-separator fluid transfer pump
P₅—Absorbing ejector fluid feed pump
P₆—Absorber feed tank-absorber fluid transfer pump
P₇—Separator-absorber feed tank fluid transfer pump
P₈—Separator-evaporator feed tank heat transfer fluid circulation pump
P₉—Separator-evaporator heat transfer fluid circulation pump
P₁₀—Separator-evaporator fluid transfer pump
P₁₁—Separator-condenser heat transfer fluid circulation pump
EV—Expansion valve
V₁—K₁ heat source left container heat transfer fluid outlet valve
V₂—K₁ heat source left container heat transfer fluid inlet valve
V₃—K₁ heat source right container heat transfer fluid outlet valve
V₄—K₁ heat source right container heat transfer fluid inlet valve
V₅—K₂ heat source left container heat transfer fluid outlet valve
V₆—K₂ heat source left container heat transfer fluid inlet valve
V₇—K₂ heat source right container heat transfer fluid outlet valve
V₈—K₂ heat source right container heat transfer fluid inlet valve
V₉—K₃ heat source left container heat transfer fluid outlet valve
V₁₀—K₃ heat source left container heat transfer fluid inlet valve
V₁₁—K₃ heat source right container heat transfer fluid outlet valve
V₁₂—K₃ heat source right container heat transfer fluid inlet valve
V₁₃—K₄ heat source left container heat transfer fluid outlet valve
V₁₄—K₄ heat source left container heat transfer fluid inlet valve
V₁₅—K₄ heat source right container heat transfer fluid outlet valve
V₁₆—K₄ heat source right container heat transfer fluid inlet valve
V₁₇—K₅ heat source left container heat transfer fluid outlet valve
V₁₈—K₅ heat source left container heat transfer fluid inlet valve
V₁₉—K₅ heat source right container heat transfer fluid outlet valve
V₂₀—K₅ heat source right container heat transfer fluid inlet valve
V₂₁—Absorber rich solution outlet valve
V₂₂—Absorber lean solution inlet valve
V₂₃—Evaporator-evaporator feed tank fluid transfer valve
V₂₄—Separator-evaporator feed tank fluid transfer valve
V₂₅—Separator-evaporator feed tank vapor transfer valve
CR—Cooling compressor
M₁N₁—Left container heat transfer line
M₂N₂—Right container heat transfer line
M₃N₃—Absorber heat transfer line
D₁-D₂ Induced coil bridge diodes
FD₁-FD₂ Induced coil current direction control photodiodes
Rla₁-Rla₂-Rlb₁-Rlb₂ Induced coil current direction control magnetic Reed relays
R₁-R₂ Induced coil current bridge resistances
R₃—Main circuit current bridge resistance

### Theory

Theory is completely within the scope physical-chemistry and it is general. It is possible to project a lot of continuous cycle very different chemical format. Continuous cycle is combinated chemical reaction system in which A+B [symbol] AB format homogeneous chemical reaction is controlled with having partner B component B+C→BC format mono direction chemical reaction. There are two type continuous cycles according to decomposition mechanism of mono direction chemical reaction.

### 1—Thermic Controlled Continuous Cycle

Mono direction chemical reaction is decompositioned by using heat. To be used the mono direction chemical reaction occurs under a single temperature t=k ° C. and it decompositions on same k temperature. If united chemical system is filled in a container, that below reaction systems occur according to temperature k.

Under k temperature;

(AB)ₙ₋₁+A+B+Cn→An+nBC

On k temperature;

An+nBC→(AB)ₙ₋₁+A+B+Cn

Need conditions for running continuous cycle of system:

a—Homogeneous reaction heat (Qh) have to be bigger than mono direction chemical reaction heat (Qc), because it is used for decomposition reaction.
b—A+C→AC reaction must not become.
c—System can be need special conditions according to used chemical components. System carrys the (Qh-Qc) heat from T₁ cold source to T₂ hot source on the between T₂>k>T₁ if conditions are formed. Total reaction heat is negative under k temperature. If free component B have in system, mono direction chemical reaction occurs always under k temperature. There is always free component B in the system because main reaction is homogeneous reaction. Necessary heat for the reaction is supplyed by T₁ cold source.

### 2—Active Controlled Continuous Cycle

Difference from first system is be different decomposition mechanism of control reaction. Thermic controlled system is contrary only laws of thermodynamics but active controlled system is continuous self-controlled system at the constant temperature and it is contrary also the conservation of energy law. Equilibrium position of system is not available in the theory and aplication. Thermic controlled system have been used prototype devices in spite of fact that active controlled system is not need heat because active controlled system is have some problems in the aplication so that solving of they is too difficult. Active controlled system may be used for some special works and it is studied form of chemical equilibrium law considering continuously instability. Active controlled system have been given for be theoric importance and for complete subject. Aactive controlled system is same of first system by being chemical format but its main working principle is too different. Using the control reaction in this system gives different pecualirity decomposition reaction according to physical conditions of reaction at the constant temperature. Cause of this is change direction of Gibbs free energy or its is draw near to zero by decreasing. In this method; reaction mechanism is controlled by changing phase at the constant temperature. For this reason; A, B and AB materials are liquid and C and BC materials are solid. This format is needed condition for the system. Given condition is able to separate condition of mixture components from each other by using simple physical metods. For example; system is completely liquid phase but if in the system occurs two liquid phase so that if homogeneous and mono direction systems do not mix with each other; given condition is supplied. Main principle of system is this. Because cause of continuously motion is be lacking in a phase and equilibrium component is not enough amount will be able to occur equilibrium. Under k temperature the for the constant one temperature point; if B component is liquid phase, exchange of Gibbs free energy is negative and B+C→BC reaction is mono direction and voluntary.

BC solid material is stable within the liquid phase. If BC solid material is taken off from within the liquid phase, it becomes unstable. BC gives heterogeneous equilibrium decompose reaction or heterogeneous mono direction decompose reaction according to exchange of Gibbs free energy. For this reason; control reaction are have diode pecualirity by being depend on phase. Turning back of reaction is imposible by using same line. In this position;

Bliquid+Csolid→BCsolid [symbol] Bgas+Csolid or

Bliquid+Csolid→BCsolid→Bgas+Csolid decompose reactions occur.

When the A+B [symbol] AB homogeneous sistem were added to within the up reaction system in such a way that it will be able to decrased activity of B and it will be able to take the B to within the liquid phase; if amount of B is set a limit, considered B component's is be equilibrium component of combined system; that is to say, if B is nonexistent enough amount in the system in such a way that it will not be able to occur equilibrium, combined system are continuously and lose its equilibrium system. At the result; active control are homogeneous-heterogeneous combined phases so that its partner equilibrium component amount is set a limit in such a way that equilibrium will be not occur. Coercing couse to get motion the system is

Bliquid+Csolid→BCsolid mono direction transition reaction on the liquid-solid contact surface. Cause of motion is stability of BC on the solid-gas contact surface and cause of motion is activity of B within the liquid phase on the gas-liquid contact surface. For this reason; three force vectors act on the system and resultant vector is continuously circulation motion vector. Active controlled cycle have been called thermic diode cycle and thermic transistor cycle according to be A or B of carrying heat component by reason of the fact that them of structure is be similar with electronic diode and transistor.

### Theoric Thermic Diode Cycle

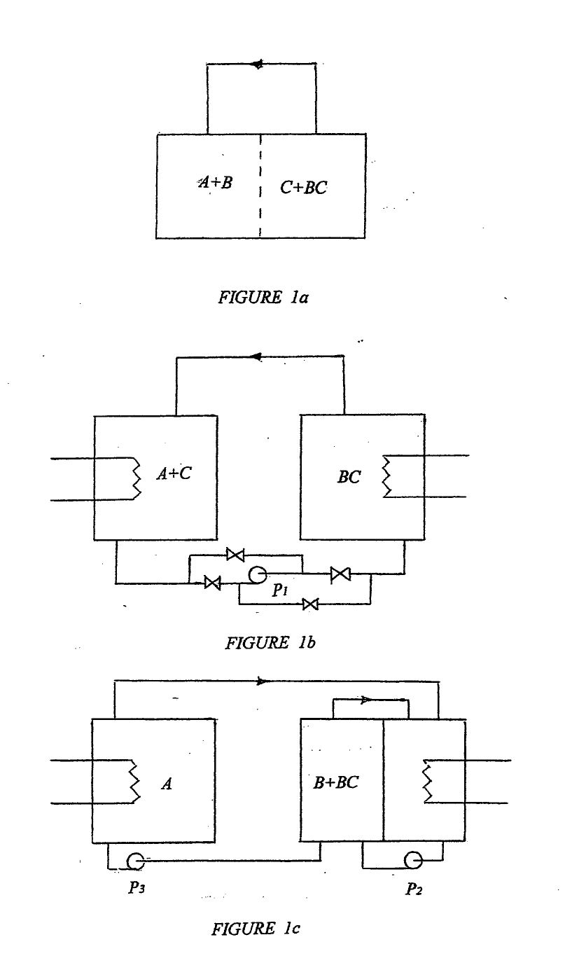

System was given on the FIG. 1a, like formed electronic structure, for be understood of matter. This confirm is impossible in the aplication. A+B+AB liquid homogeneous system and C+BC solid heterogeneous system is placed within a closed container in such a way that they will contact with each other from only single surface. Gas phases of both system are connected by using a piece of pipe. Partner equilibrium component of the combined system is B. If B is exist enough amount in the combined system, equilibrium always occurs by becoming AB+BC. If B is nonexistent enough amount in the combined system and if B activity of homogeneous system is less than B activity of heterogeneous system, equilibribrium constitution is impossible within the combined system thermic or dynamic. Limiting amount of equilibrium component and activity conditions must togather supply same time for continuously motion. Cause of continuously motion is activity difference. If limiting amount of equilibrium component condition is supplied only, motion doesn't occur. Because activity force is opposite direction to motion. In the practice; B activity is zero within the homogeneous system for diode cycle. B is available for only B+C→BC reaction. A+B [symbol] AB reaction is transition reaction and homogeneous phase is contain only pure A component in the theory.

Theoric thermic diode is a mechanic continuously machine. Because its reaction system have been got short circuit from the point of wiew thermic. Reaction and decompose reaction heats are equal to each other and symmetrical. Temperature doesn't change and it is constant.

Working of system: Gas B comes on the homogeneous system from within of the pipe in which it be constituted by decomposition of BC and it passes into liquid phase by A+B [symbol] AB reaction. Reaction was given double direction but B activity is zero and A is pure for diode cycle. For this reason; real total reaction system is mono direction. System comes to starting point sudenly for the AB is be contact with C by A+B→AB→AB+C→A+BC chain reaction and cycle finishes.

### Practical Thermic Diode Cycle

The experiment device was given FIG. 1b. Symmetrical two containers are used for the practical thermic diode cycle and its bottom floor sides are connected each other by using having double direction a hydraulic pump (P₁). Same amount C component is filled within the containers. B component is filled in such a way that it will only enough for one container. Amount of A is udjusted in such a way that BC component willl be competely within the liquid A phase.

Working of the system: System was given in the starting point on the figure in such a way that it will carry heat from right to left. B vapor comes from right container to left container by passing from within the pipe in which it be constituted by decompose reaction of BC. B is taken into solid BC phase by A+B→AB+C→A+BC chain reaction. Right container takes BC→B+C the decomposition reaction heat from cold source and it gets cold. Left container gets warm. Because while BC is occurring by chain reaction, same heat becomes. When the carrying heat finished, A+BC mixture become within the left container. There is only C within the right container. In this point; P₁ pump takes a component to within the right container on C. System runs again at the opposite heat cary position from left to right. Thermic diode is too simple but it is have problems so that them solve are too difficult. Important problems: System contains solid phase and heat conductivity of used solid materials are too lees. For this reason; heat transfer and process speed problems are available.

### Thermic Transistor Cycle

This cycle have been projected for decrease process speed and heat transfer problems of diode cycle. It may be used for some special working but it is not suitable for universal using. Experiment device was given FIG. 1c. Chemical reaction system is done short circuit from the point of wiew thermic in this cycle. Activity of B is adjusted in such a way that the system will able to run normally at optimum value. Carriying heat in the system is evaporation heat of A. Cycle is used;

Agas+Bgas+Csolid→ABliquid+Csolid→Aliquid+BCsolid→Aliquid+Aliquid+Bgas+Csolid

the chain reaction system. System carrys the heat difference between to system enter and from system exit for it is symmetric and it be done thermic short circuit. A enters to in the system at gas phase and it goes out from in system at liquid phase. Heat flow is linear on the contrary of diode cycle. In the FIG. 1c; left container is cold source and right container is hot source. Right container in which it is hot source, it is have two parts. First part in which it is left side of right container, it is filled with BC material. Second part in which it is right side of right container, it is unit occurring homogeneous reaction and it is empty on the operation beginning. Left container in which it is cold source and it is filled with liquid A material. Vapor phases of parts of right container are connected each other by using a pipe and them floor bottom sides are connected each other by using another a pipe through P₂ hydraulic pump. Vapor phase of left container is connected to up side right part of right container by using a pipe and its floor bottom side is connected to floor bottom side left part of right container through P₃ hydraulic pump.

Working of system: System was given on the beginning position. A evaporates from in the left container and B occurs by BC [symbol] B+C decomposition reaction in the left part of right container. They go to right part of right container through separate pipes and they get occur liquid phase by A+B [symbol] AB reaction. Left container gets colder for A evaporates. Right container gets warm for reaction occurs. When the device stoped, A material have been carried competely. There is only C within the left part of right container and there is AB whitin the right part of right container. In this point; AB is taken on the C by P₂ pump. Free liquid A becomes by AB+C→A+BC reaction. P₃ pump takes the A within the left container and system beginning run again.

### Results

Only thermic controlled system is competely chemical format in sipite of fact that both them have been given chemical format. Active control only requires mono direction reaction. To realize is possible this cycle with homogeneous physical systems, suiting or partly suiting to 2. Rault law in such a way that one of its components will be able to chemical reaction with C. The reaction heat is no important for active control. Because mono direction reaction occurs and decomposes at the same temperature in the theory. A isothermic feedback circuit gets rid of effect on the system of reaction heat in spite of the fact that it is impossible in the practice. Thermic controlled method have been used for prototype devices. Homogeneous reaction heat is variable and it increases when the temperature difference increased. This is bad feature of thermic controlled method. Qh=Qk becomes for at a definite temperature difference and system stops. Active controlled system is real continuously as it is have naturel feedback. For this reason feed back circuit have been occurred by adding other third a closed heat source to in thermic controlled system. Definite of mono direction reaction heat is no exist on the system at under temperatures of feed back source temperature. Siystem only carrys Qh heat. To project is possible electrochemical cell outputting electric for both system is chemical format. It is not projected for no advantage.

### Simple Continuous Cycle Machine and Chemical Structure

A special continuous cycle system have been formed by using a special chemical material groups in sipite of fact that theory is general. In this cycle; component A is a liquid, giving homogeneous reaction with water and B is water and componet C is a solid hydrate salt. Simple continuous machine was projected in such a way that it will take the liquid water and it will discharge its to atmosphere at the gas phase. The main working principle of machine is to take the water into solid phase from within the mixture by being chemical hydrate form in a thermodynamics absorbtion cooling cycle in which one of its components is water and hydrate salt's is get dehydrate by atmosphere air. This machine had not supplied enough process speed. Problem was solved with thermic and active controlled cycle methods so that self separation and keeping of water within the system was supplied. In this format;

A+B [symbol] AB homogeneous reaction is a absorbtion reaction and B+C→BC mono direction reaction is hydration reaction. This special cycle may be define like that it is homogeneous thermodynamics absobtion cycle, getting chemical separation, having self separation feature, being water one of its fluids. Same combined structure may be formed by using NH₃ or alcohol instead of water and ammonia or alcohol complex salt composition instead of hydrate salt in the complex chemistry. Study was not done. Used chemical combines for the thermic controlled cycle given below.

NH₃+10H₂O+Na₂SO₄ [symbol] NH₃aq+Na₂SO₄→NH₃liq+Na₂SO₄10H₂O.solid

Turning temperature is k=32.7° C. for reaction.

HCl+2H₂O+NaCl [symbol] HClaq+NaCl→HCl+NaCl2H₂O

Turning temperature is k=0° C. for reaction.

HBr+2H₂O+NaBr [symbol] HBraq+NaBr→HBr+NaBr2H₂O

Turning temperature is k=30° C. for reaction.

HI+2H₂O+NaI [symbol] HIaq+NaI→HI+NaI2H₂O

Turning temperature is k=30° C. for reaction.

Active controlled system may be realized with same combines under turnning temperatures. That combines was used being add to up combines for partly chemical active control. Purpose them is experimental.

For the A component: Di methyl ether, formaldehyde, acetaldehyde, cyclopropan and ketone-alcohol (acetol)

For the C component: Na₂CO₃, MgSO₄, ZnSO₄, Na₂B₄O₇

### Simple Continuous Machine

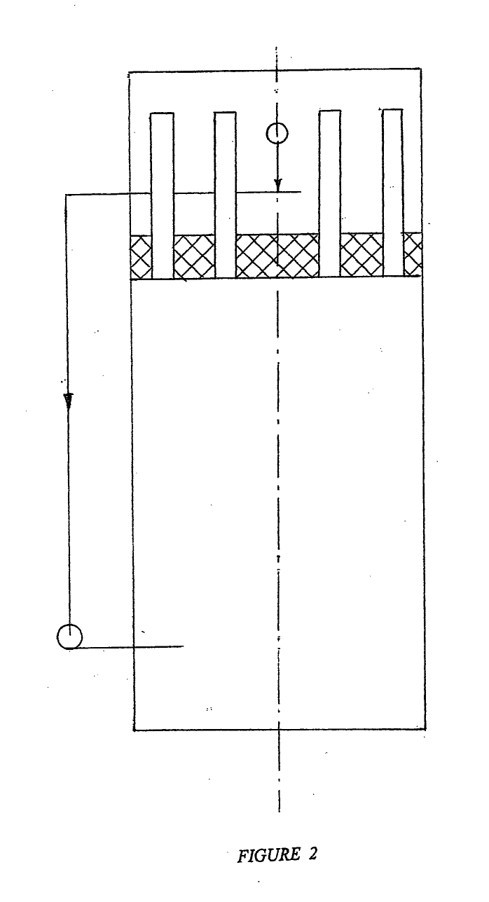

Done mistake in the thermodynamics is that. Gases don't mix with each other homogeneously whitin the atmosphere with gravity. Dalton and Amagat laws may be true accept for no important working and this is no important. But both laws are wrong for general cosmic structure and this is too important for continuously mechanism. It is impossible constitution of a natural thermodynamics system at without gravity a place and Carnot's thermodynamics is special state idealized. Discuss is meaningless truth of subject because industrial aplications of subject are available. For example; gas centrifuge technique is used to separate the uranium isotopes. To separate is impossible the homogeneous structure by this technique. For this reason; having light density components swim whitin the having heavy density components in the atmosphere. If a thermodynamics fluid is not available in the structure at the phase transformation temperature limits; subject is no important. But if it is available, system is too important and it is continuously structure. In the phase transformation temperature limits fluid is water for world. Water evaporates from the face of the earth and it does two motions. It goes towards to sky by reason of the fact that atmosphere lifts it and it expands polytropic continuously to within atmosphere. At the end point of this expansion is point becoming its ice competely. To say is wrong, its will not get cold and its will do diffusion. Because steam does working opposite of gravity. For this reason; diffusion laws are wrong too for having gravity surroundings and cold air doesn't get cold the water steam on the contrary; water steam gets cold the air in the sky. Naturel open system have been studied by taking whitin a closed container. Continuously result didn't change whitin the closed container. Only polytropic expansion process transformed to polytropic compression process. Simple continuous machine was given FIG. 2. This device is also experiment device. It is cylindirical a cloced container, separated two parts from up side by disc in such a way that its height will not neglect of gravity. Passing vapor pipes have been assembled on the separation disc. A siphon mechanism was placed middle of the up part. The exit of siphon was connected to bottom side by using a pipe trough a hydraulic wheel. Experiments was done by charging pure fluids, mixture fluids and hydrate sulp salt materials to in the bottom of device. All fluids was carried to in of up part so that device is get insulated or uninsulated thermic. Natural structure was transformed chemical format for less be transported speed by taking into consideration result-reason relatedness. The dehydrate sodium carbonate was filled to the floor of device in such a way that it will stay on the amount at the solid phase. %20 ammonia-water mixture was filled to in up part in such a way that siphon mechanism will open up amount. In this point; siphon mechanism open up and middle of mixture flow down from up part. sodium carbonate deca hydrate be formed by hydrate reaction at floor of device and ammonia begins evaporation. While bottom side is beginning get cold, up side begins get warm. When ammonia finished on bottom side, system gets equilibrium slowly and dehydrate reaction begins. Because vapor pressure on of salt is high than partly water steam pressure on of fluid mixture. (active controlled system) Steam condensation is impossible on the solid salt. Because both vapor are at the superheat area on the fluid mixture. When the reaction finished, siphon start up again. Hydraulic wheel have been put for conversation of energy law. It may be dicussed.

Alternative Thermic Modifier

It operates by using with feedback thermic controlled cycle principles. Prototype device is projected for ammonia-water cycle. Feedback system is not need for the acid cycles. Because stop point is outside of atmosphere thermic limits. The mounting cross section drawings of device was given FIG. 3a and look from upside drawings of device was given FIG. 3b. (2) and (3) number parts are heat battery containers in which they are insulated thermic from outside and them upsides are open. (4) number part is closed tube. Tubes in the both containers are welded on the cover (1) of devices and outlet of tubes are connected on the manifolds (5) by using pipes. Tube (4) groups constitute cooling battery or heating battery in the both containers (2-3) according to operating direction of device. Operation of device is controlled by being changed temperatures of heat transfer lines fluids (M₁N₁-M₂N₂). Two pipes are placed in every tube (4). Coming pipes are absorbing pipes from bottom of tubes to on manifolds (5) and coming pipes are evaporation pipes from whitin of upside tubes to on manifolds (5) Pipes of two battery are connected each others asymmetrical from by passing through manifolds. (5) (Absorbing pipes of left battery are connected to evaporation pipes of right battery and evaporation pipes of left battery are connected to absorbing pipes of right battery.) Checkvalves (6) are placed between two parallel manifolds for to be single direction of steam flow, from evaporation to absorbtion. While the left container (2) is running by being cold source on the FIG. 3a, flow direction is from left to right whithin the up pipe lines. While it is running by being hot source flow direction is from right to left within the below pipe lines. The flow is not available simultaneously in the two pipe lines.

The tubes are filled with having ten mol water sodium sulphate hydrate and dehydrate natirium sulphate solid salt in such a way that sulp Na₂SO₄ 7H₂O format will be suplied. Cause of this; sodium sulphate is not have reversible transformation temperature within the saturated solution. In the general; salt settles from saturated solution by taking seven mol water in the metastable hydrate form, and after it transforms stable format having ten mol water hydrate. 65 gr NH₃ is chargeded within the systems for per 100 ml of becoming saturated solution. Machine is have the maximum performance in this format between −21° C.+60° C. Temperatures are useable source temperatures. Temperatures are between −30° C.+70° C. in the device. Operating of machine is controlled by electro-mechanic valve system given FIG. 4. Control mechanism of modifier is too comlex in spite of fact the that modifier is too simple construct. For this reason; before circuit parts will be defined, after working of system will be explaned in the list items. On the FIG. 4; K is heat source and there are five heat sources in the system. Sources are filled with melting at the constant temperature materials and them temperature are constant, only K₄ outside. K₁ source is filled with Na₂B₄O₇10H₂ solid salt and its constant temperature is 60° C. K₂ source is filled with phenol and its constant temperature is 40° C. This temperature is min. temperature of hot source for ammonia-water cycle. K₃ source is filled with paraldehyde. It is feedback source and its constant temperature is 12° C. K₄ source is atmosphere heat source and its temperature is not constant. If device is operating under 0° C. climate conditions heating purpose, temperature may be become fixed by using liquid water. This aplication is important for the operating performance and cleaning water by using freeze technique. K₅ source is filled saturated NaCl-water solution and its constant temperature is −21° C. Device is projected for the universal using heat on the between −21° C.+60° C. temperatures. If device will be used for simple works, no need five sources. For example; if it will be used for air condition system, no need K₁ and K₅ sources. If it will be used for production pure water from sea water and used water, also no need K₃ source.

FP is heat transfer fluid circulation pump and there are two pumps in the system. Both pumps run cotinual while device was operating. (FP₁) pump feeds (M₁N₁) heat transfer fluid line in the left container (2). (FP₂) pump feeds (M₂N₂) heat transfer fluid line in the right container (3). (EV) is expension valve and it is on the Ru cooling-heating line between two pumps (FP₁-FP₂). This cooling-heating line is need only to start up the device. V is magnetic control valve (solenoid valve) and there are twenty valves. There are four valves on every source, two inlet valves and two outlet valves. Valve is not need for the outlet line of sources, they are put for the maintaining and repair easily. Operating of device is controlled by this valves. They are opened or closed coming warnings from pressure and temperature sensors in the containers.

Start Up of Device:

When the machine was started up; electro stop check valves (6) be shut, (V₅V₆V₁₁V₁₂) magnetic control valves be opened. (FP₁) and (FP₂) pumps begin running. Cooling compressor begins running. Smallest source in the system is K₃. Amount of heat in its is limited in such a manner that it will be able to occur hydration reaction. When the temperature of K₃ source came down under 12° C., low temperature starting sensor makes warning and device begins normal operating. In this point; the solid hydrate salt in battery of left container (2) changes phase by become melting and it passes liquid phase. Left container battery is absorber units in this point. Salt in the right container (3) battery is solid hydrate as it get cold and ammonia in the right container (3) battery is pure free liquid pysical phase. Right battery is evaporator unit in this point. Cooling compressor (CR) stops. Electrostop checkvalves (6) be opened on the normal working position. V₁₁-V₁₂ valves be shut and V₁₉-V₂₀ valves be opened. 10° C. temperature difference was used for heat transfer in the device. When the temperature difference came down under 10° C. between K₂ source with absorber, V₁₉-V₂₀ valves be shut and V₁₅-V₁₆ valves be opened by sensor warning. Device makes passing to K₄ source. When the temperature difference came down under 10° C. again; V₁₅-V₁₆ valves be shut and V₁₁-V₁₂ valves be opened. Device makes passing K₃ source. When the temperature difference came down under 10° C.; last warning cames. In this point; first steep operating of device is finished. V₅,V₆,V₁₁,V₁₂ valves be closed, V₁,V₂,V₇,V₈ valves be opened. FP1 and FP₂ pumps exchanges heat battery, in such a way that K₂ source will be cold source and K₁ source will be hot source. Pressure go down suddenly for become less ammonia and melting salt partly and temperature of K₂ source is higher than transistion temperature of salt in the evaporator battery. Direction of difference pressure changes. V₁-V₂ valves be shut and V₉-V₁₀ valves be opened and electro checkvalves (6) be shut and device makes passing feedback heat sources with warning come from pressure sensor. When the salt in the left container (2) battery becomes passing solid phase and pressure get high and V₉-V₁₀ valves be shut and V₁₇-V₁₈ valves be openned and electrostop checkvalves (6) takes normal operating position with warning sensor. In this point; device finishs single alternance of alternative operating motion and it begins first steep of another alternance. Material and heat flow in the batterys turns opposite direction. Device operates with two steps. Mean of step is that. Main hot source of unit is K₂. Device carrys the heat at the right time from K₅, K₄ and K₃ to K₂ in the interval first steep operating. After it carrys carried heat in the K₂ to K₁, in the second steep operating. Cause of this operating form is be too less of caning heat the between operating temperature limits of device if it operates one steep for ammonia cycle. Purpose is to increase heat capacity of device. Heat capacity is too big for acid cycle. Step and feedback is no need. Operating steep of device have been given below. In the starting point; left container battery (2) is absorber and right container battery (3) is evaporator.

| Magnetic control valves | Heat sources |
|---|---|
| 5-6-19-20 open | heat is carried from 5 to 2 |
| 5-6-15-16 open | heat is carried from 4 to 2 |
| 5-6-11-12 open | heat is carried from 3 to 2 |
| 1-2-7-8 open | heat is carried from 2 to 1 |
| 7-8-9-10 open, electro stop check valves(6) | |
| shut. Machine changes running direction | |
| by using K₂ and K₃ heat | |
| sources of feedback line and positive | |
| alternance is finished. | |
| 7-8-17-18 open | heat is carried from 5 to 2 |
| 7-8-13-14 open | heat is carried from 4 to 2 |
| 7-8-9-10 open | heat is carried from 3 to 2 |
| 3-4-5-6 open | heat is carried from 2 to 1 |
| 11-12-5-6 open, electro stop check valves | |
| shut(6). Machine changes running direction | |
| by using K₂ and K₃ heat | |
| sources of feedback line. And machine | |
| finishs alternative motion. It continues | |
| running from normal running point of | |
| departure again. Control row of valves | |
| were given for in winter in such a way that | |
| temperature of atmosphere will be less | |
| than feedback source. (12° C.) 5-4-3 | |
| heat transfer row of source must be changed | |
| in such a way that it will be 5-3-4 | |
| for in summer. | |

Cycle Technique Data

It may be used Na₂SO₄, NaCl, NaBr, NaI for ammonia-water cycle in the thermic controlled system but it is impossible to use another salt. Because using salt must be neutral. Another neutral hydrate salt is not available in the alkali elements and ammonia gives chemical reaction another elements. Hydrate salts of potassium and other hydrate salts of sodium are too strong basic and solubilty of ammonia is too lesss within this salt solutions. Lithium salts give comlex reaction with ammonia. Ammonia dissolves in the saturated sodium sulfate solution free of problems. When the normal NH₃—H₂O solubility diagram used, done mistake don't pass % 5. Temperature of absorber battery, temperature of evaporator battery, pressures and carried heats are given below for the ideal situtation.

| | Evaporator | | Heat kj For mol |
|---|---|---|---|
| Absorber temp. ° C. | temp. ° C. | Pressure kPa | Na₂SO₄ 10 H₂0 |
| 50 | −30 | 119 | 63 |
| 50 | −10 | 290 | 57 |
| 50 | 2 | 462 | 66 |
| 70 | 30 | 1166 | 52 |

Total carrying heat of machine is (63+57+66)=186 kj for 40° C. source. Left heat to this source is 265 kj. Difference between left heat with carried heat is dissolve heat of ammonia within the water. Device takes 52 kj of this heat for 60° C. source and it lefts the 72 kj theoric heat to this source togather dissolve heat. Taking heat for feedback source is 66 kj. This heat is less than hydration reaction

Na₂SO₄+10H₂O→Na₂SO₄10H₂O 78 kj but, in the NH₃ aq+Na₂SO₄→NH₃+Na₂SO₄10H₂O reaction; there are 9.7 mol ammonia and 10 mol water. Reaction is mono direction and taking heat form by reason of the fact that there are dissolve heat. System gets cold by taking 12 kj heat.-21° C. heat source was put for refrigerator. To form is more easy and cheap aplication a cooling room within a hause than refrigerator, because carrying heat of system is too much than a refrigerator. 60° C. K₁ source was put for using kitchen and bathroom on the assumption that heating was done by air. If heating is being done by using hot water, it must need to carry all of caried heat to 40° C. source to 60° C. by balancing operating steep.

St 37 steel was used for construct device. Steel pipe (DIN 2450/51 ND 50 D=70 s=3) was used for construct tubes. Δt=10° C. min. temperature difference was used for heat transfer in the device. In this conditions min. heat power of device is 150 KW/m² according to heat transfer surface field of battery. Acid cycle is more good 5 multiple according to heat performance and temperature difference. But advantage is not much the temperature difference for alternative structure. Acid cycle was used direct continuous thermic modifier by reason of the fact that construct materials are expensive and it is more suitable to purpose.

Direct Thermic Modifier

Ammonia and acids cycles are partly different from each other according to chemical and pysical features of used subtances. HBr acid cycle was used in the prototype device. Ammonia cycle was used in the thermodynamics continuous cycle machine and details of ammonia cycle are going to be given same part.

The general purpose projecting of the direct thermic modifier is to carry the high capacity heat on the between high temperature difference. Therefore device was projected being heat source for power santral and ship main engine. It is not suitable for universal personal using because it is unsafe. Dangerous chemical substances in the alternative modifier are insullated from the outside and leakage is impossible. Leakage may be become on moving heat transfer fluid line and this is not dangerous. Therefore alternative modifier is able to personal using safe. Transfer of chemical substances is need in the direct thermic modifier cycle. Device can be safe used by trained personnel only. Direct thermic modifier cycle flow diagram for acid was given FIG. 5. Cycle is classic thermodynamics absorbtion cooling cycle having chemical separator with simple form. On the FIG. 5; 7 number part is evaporator, 8 number part is absorber, 10 number part is separated part heat exchanger, 11 number part is separator, 9 number part is evaporator feed tank, 12 number part is absorber feed tank.

There are HBr acid solution in the absorber (8) in which its concentration changes between 0.4-0.48 acid. Max. concentration is 0.48 and it is azeotropique solution. Cause of choosing between this values; solution gives max. boiling point and min. pressure. To reach is possible higher temperatures out of in this point but pressure gets high. This is unsafe because chemical subtances in the device is too much active. Second cause of this choosing is chemical feature of chemical substances. This features constitution the different point between acid cycle and ammonia cycle. Ammonia dissolves in the saturated salt solution free of problems. Occurring solid salt wreckage in the solution is impossible. But on the contrary situtation is available for acid cycles. The salt is not dissolve in the acid solution because same partner ion is exist in the solution and chemical activity of acid is too high than salt. In this position; if the occurring saturated salt solution in the separator (11) is taken within to the absorber (8) the solid salt settles when the acid's concentration got high. So, all of salt in the separator is carried to in absorber and cycle system is become shut down. Therefore pure water or without salt acid solution must be fed to within the absorber. Acid contcentration of acid in the evaporator (7) is between 0.7-0.8 values and it was choosed in such a way that its max. temperature will be 0° C. To adjust is possible its temperature for different points low and high by adjusting acid concentration.

### Operating Device:

Coming acid vapor from evaporator (7) is taken into acid solution in the absorber (8) by using absorbing ejector system in which it is fed by P₅ pump. Pressure in the absorber (8) is boiling pressure at the ambience condintions and pressure in the evaporator (7) is big only a little than absorber. Cause of using absorbing ejector is to speed up absorbtion by enlarging touch surface in spite of the fact that positive pressure difference is available. Boiling point of acid solution is 126° C. in this conditions and its changing chemical equilibrium is too speed. Therefore big touch surface and good heat transfer conditions are needed. Absorbing ejector system increase touch surface it also speeds up heat transfer because it get moving continual the acid solution. Left heat to in the absorber is transferred to hot source through absorber heat exchanger with M₃N₃ heat transfer line. Acid in the absorber is taken in the separator (11) at intervals from within having three part and opposite flow heat exchanger (10).

If separated part heat exchanger (10) is not available in the system; it can operate at % 50 heat performance for 60° C. temperature difference limit. If there are not add a equipment for to preserve the heat, to increase is impossible the heat performance of system. Heat performance of cycle about is %50, operating in the design value limits and using a heat exchanger. Because needed mono direction reaction heat for to melt the hydrate salt is 100 Kcal/kg H₂O and this heat is equal the half of absorbtion heat at 126° C. If separeted part heat exchanger is noexistent, this device don't carry heat, because needed heat is about same for to raise the temperature of acid solution to absorber temperature and this heat is carriying heat of device. Therefore if heat exchanger is noexistent system don't run. Even heat exchanger could run at the ideal diferansiyel temperature difference, max. heat would be able to carry is (Qh-Qk). Three different aplication was projected for to use all of homogeneous reaction heat taken into consideration system's too costliness. Having 40° C. source is needed for to melt the salt. For this reason; to use is not very sensible the absorber line for this work. In the first aplication; heat is taken by using a classic heat pump from atmosphere. In the second aplication; system is combined the ammonia continuous cycle. Third aplication is feedback and it was used in the prototype device.

Separated part heat exchanger (10) is full completely and V₂₁-V₂₂ valves are shut on the beginning separation. Acid is taken into separator (11) the equal amount to twenty percent of acid in the bottom part of separated part heat exchanger (10) by V₂₄ valve, from whithin evaporator feed tank (9). P₄ pump adds acid in the bottom part of separated part heat exchanger (10) to whithin separator (11). P₄ pump stops and decrased acid in the separated part heat exchanger is completed by using V₂₁ valve. P₉ pump on the evaporator by-pass heat transfer line begins running and separator (11) begins get cold. When the pressure in the separator (11) get high up of pressure in evaporator feed tank, (9) V₂₅ valve be opened and acid vapor in the separator (11) is absorbed by the acid solution in the evaporator feed tank (9). Temperature of evaporator feed tank is constant at the 40° C. and it is feedback source of device. During this absorbtion; heat transfer flow direction in the evaporator by-pass heat transfer line changes and given heat to evaporator (7) is taken back. When the pressure difference between evaporator feed tank with separator become less; V₂₅ valve is shut and P₉ pump stops and P₁₀ pump begins running. Rich acid solution in the separator (11) is taken in the evaporator (7) by P₁₀ pump. Too much acid solution in the evaporator (7) is taken in the evaporator feed tank (9) by using V₂₃ valve. P₁₀ pump stops and acid solution in the bottom part of separated part heat exchanger (10) is taken in the separator (11) by running P₄ pump. Decreased acid solution in the separated part heat exchanger (10) is completed by using V₂₁ valve. P₈ pump begins running and separator (11) begins get warm. Hydrate salt in the separator (11) leaves free the hydrate water by melting. The acid in the separator (11) is become lean. The lean acid solution in the separator (11) is taken in absorber feed tank (12) by using P₇ pump. P₆ pump is completed decreased acid solution in the absorber (8) by using V₂₂ valve from within separated part heat exchanger.

### Cycle Technique Data

System carrys 800 kj theoric heat for kg. acid vapor between operating temperature limits 0° C.-126° C. Heat carriying yield of device is % 80 at this projecting form. All of losses occur in the separated part heat exchanger. Occurred losses from specific heats have been used in theoric yield calculation. Covered with copper duralumin was used for construct prototype device. Silver covering, tantalum and diabon (phenol-form aldehyde-graphite resin) may be used to construct device. But air leakage must obstruct from running pumps to whithin the system because acid solution dissolves copper and silver if air is exist in the system. Tantalum and diabon is safe for dissolve.

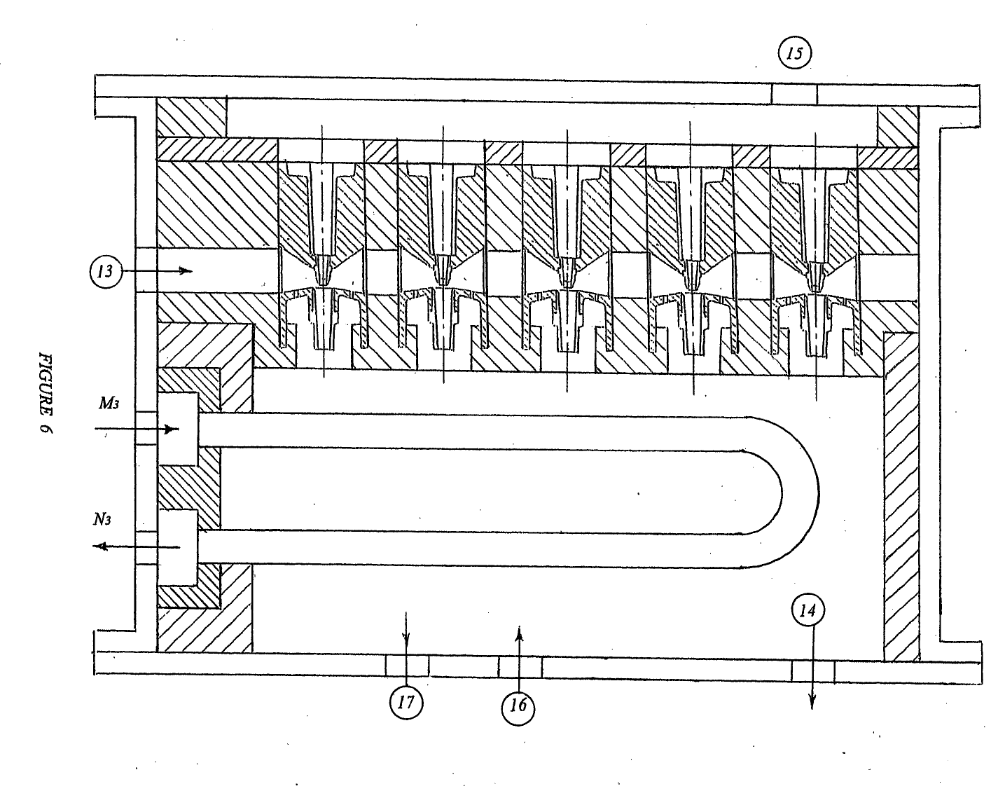

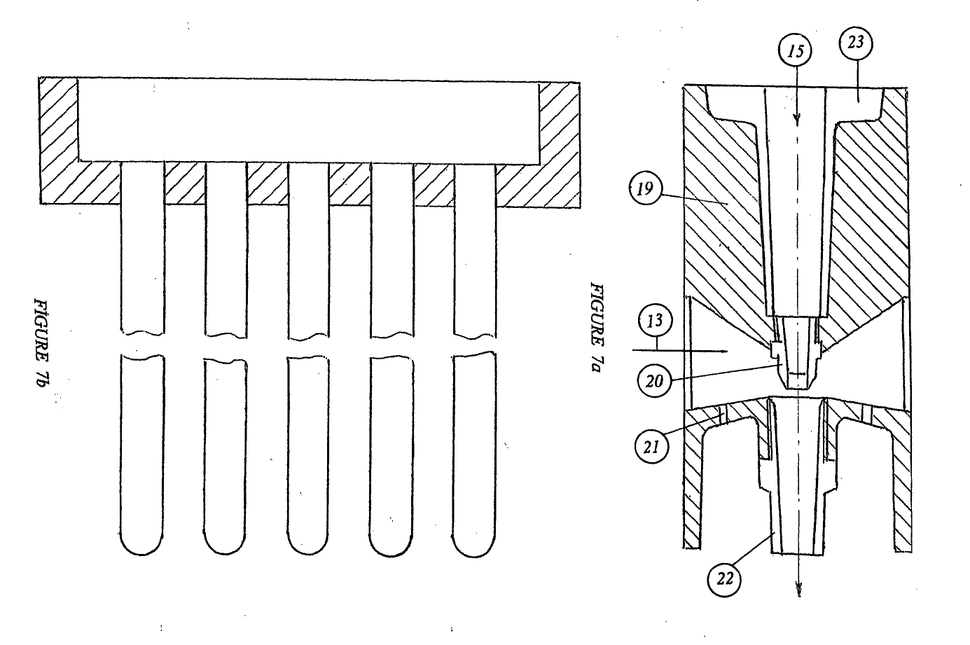

Prototype absorber (8) was given FIG. 6. It is constructed by using different frame parts and by using sandwich technique. Different hatched side parts are frame parts. Absorbing ejectors are placed upside and they are occurred battery units. Absorbing ejector is different partly from classic ejector. Its detail drawings was given FIG. 7a. On the FIG. 7a; 13 number is absorber vapor inlet from evaporator (7). 15 number is feed solution inlet. 21 number is feedback orifis. 19 number is main body block. 23 number is guide nozzle. 20 number is main nozzle. 22 number is diffuser. (20 and 22) number parts is screwed on the main body. Main purpose of absorbing ejector is to constitute contact between vapor and solution. Therefore low pressure difference is used for feed fluid. (0.25-0.5 atm.) Feedback orifis (21) is drilled for come back of no absorbing vapor. If feedback orifis is not exist, classic ejector must be used in the absorber. Because no absorbing vapor incrases the pressure. Difference of absorbing ejector from classic ejector; its diffuser is cut from on the beginning constant diameter and feedback orifis is dirilled on of its body for constant pressure. Therefore suction-press feature is not on it and it is not a pump. On the FIG. 6; heat exchanger bottom of absorber was drawn by turning 90° to seem of flow. Its real figure was given FIG. 7b. On the FIG. 6; M₃ is heat transfer fluid inlet. N₃ is heat transfer fluid outlet. 13 number is vapor inlet. 15 number is feed solution inlet. 14 number is feed solution outlet. 17 number is rich solution outlet. 16 number is lean solution inlet. Prototype absorber is main part of given three prototype devices. Absorber must be used if device will operate for high power in spite of the fact that in the alternative thermic modifier is used naturel battery system. The given prototype absorber is also condenser of thermodynamics continuous cycle machine.

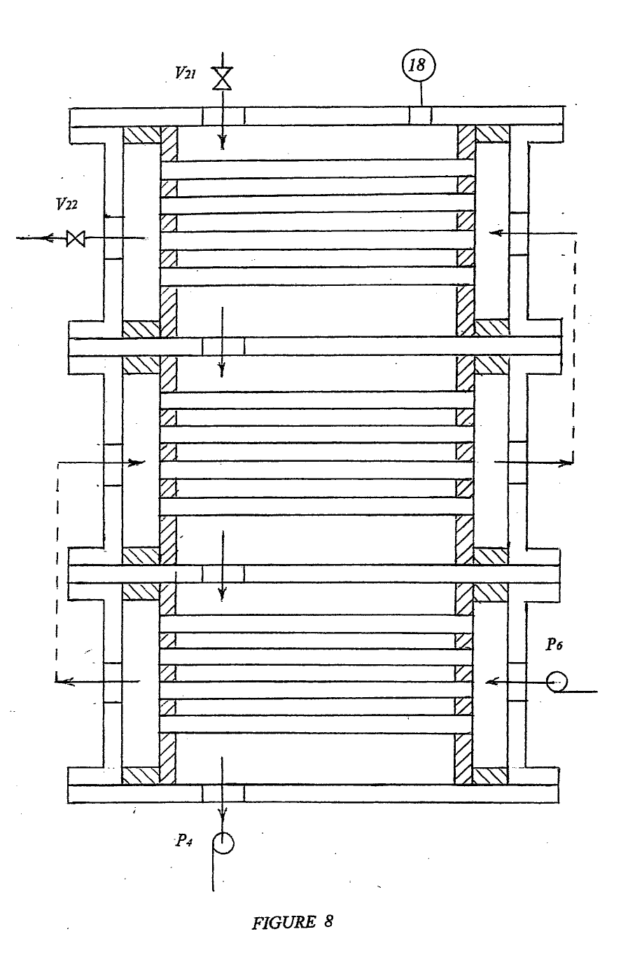

Separated part heat exchanger detail drawings was given FIG. 8. 18 number is pressure equilibrium line outlet between separator (11) with separated part heat exchanger (10).

Thermodynamics Continuous Cycle Machine

Acids or ammonia cycles may be used for machine in the theory but in practice to use is impossible acid cycles because used chemical substances are too very active. Temperature of modifier cycle is become fixed and occurring pressure diference is used for to produce mechanic energy. Used cycle is same of having feedback direct thermic modifier cycle. Name of some main parts had be changed only for discuss moving thermodynamics machine in spite of the fact that its function is same and a accouplement steam engine-electric dynamo was added in the system. Evaporator (7) is boiler and absorber (8) is condenser for this machine. Machine flow diagram was given FIG. 9. On the FIG. 9; 7 number part is boiler and it is same of evaporator in the direct modifier cycle. 8 number part is condenser and it is same of absorber in the direct modifier cycle. 11 number part is separator and it is same of separator in the direct modifier cycle. 24 number part is accouplement steam engine-dynamo. Separate feedback line is not done. Boiler (7) and condenser (8) also constitute feedback line of cycles.

### Operating of Cycle:

Boiler (7) is filled with liquid ammonia. There are two different heat transfer line within boiler (7). Shown open Qatm. line is transfer heat line from the atmosphere. Closed heat transfer line is feedback line. Temperature of boiler (7) is kept constant at the 12° C. by papaldehyde bath. Design of machine have been made according to hypothesis in such a way that temperature will not go down below of 0° C. or its will be on the water source. If temperature of atmosphere is below of 0° C., separate a feedback source is necessary for cycle on the outside of boiler. Pressure of ammonia in the boiler (7) is 600 kPa for given this conditions. Condenser (8) is within phenol bath and its temperature is constant at the 40° C. Pressure of solution in the condenser (8) is kept between 100-200 kPa. This conditions; steam engine (24) expansions the ammonia vapor by using adiabatic thermodynamics process to between (100 kPa, −33° C.).-(200 kPa, −19° C.). Stopping point of machine is −19° C. In the practice; performance of machine is depend on ambiance temperature. Performance characteristic is logaritmic and performance is too less below of 0° C. in spite of the fact that to referred is meanless from a continuous cycle machine's yield. Max. temperature lower limit of the system is 40° C. Supplying high power at the low temperatures of the machine is depend on be decreased this temperature. This temperature is characteristic value and chemical feature for ammonia cycle. For this reason; indirect be fed of machine is necessary for stationery high power in the too cold climate conditions by using a classic heat pump or modifier system the given this project; by taking into consideration machine uses single heat source and it is not give heat to atmosphere. Power of machine is constant very nearly up of 10° C. atmosphere temperatures and this power value is about 10 KW for m² of boiler (7) heat transfer surface. Separation process of solution in the condenser (8) is same with modifier cycle. On the FIG. 9; P₄ pump takes ammonia solution in the condenser to within separator in which it is full with dehydrate sodium sulfate. P₉ pump runs and water within solution passes become solid phase and ammonia is free become liquid phase by closed cooling heat transfer line of boiler (7). Liquid ammonia in the separator is transfered to boiler (7) by using P₁₀ pump. P₁₁ pump runs and hydrate salt is melted by heating heat transfer line between condenser (8) with separator. Saturated sodium sulfate solution is transferred to condenser (8) by using P₆ pump.

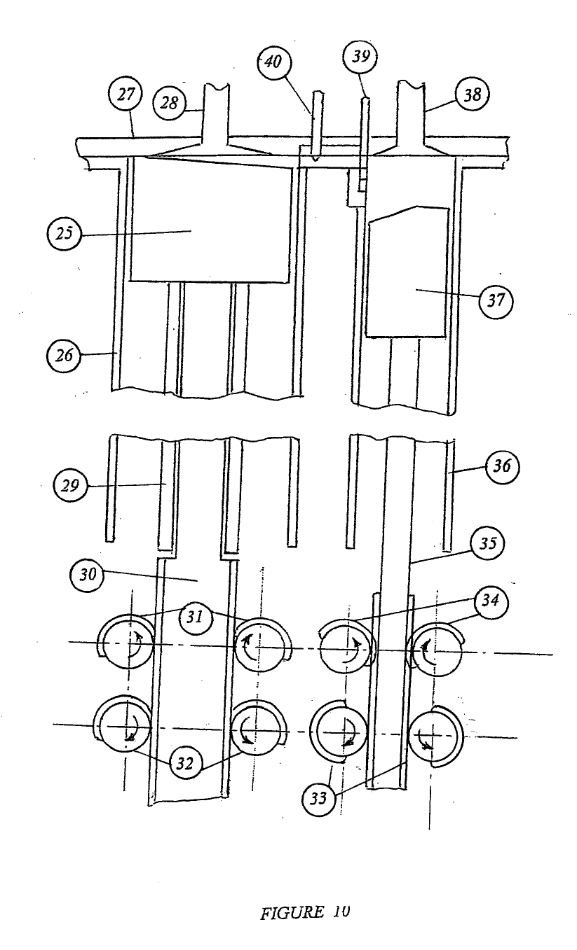

Most important component of system is steam engine for which it realizes mechanic transposition. A classic steam engine may be used in the system but occurred temperature difference is less and power of engine is too less depend on this. Therefore different a steam engine was projected for increased power. Changeable stroke polyptropic steam engine was used in the system. This steam engine is form partly be changed of changeable stroke synchronic engine in which it was projected for to realize the Brayton gas turbine cycle within the a piston engine. Changeable stroke synchronic engine is not available scientific literature. Being used mechanic transfer mechanism in this engine have been used for steam engine and accouplement dynamo. Therefore its operating and advantages will be given for be understood of matter. Simple mounting drawings of engine was given FIG. 10 and names of part number list is below.
25—Working piston
26—Working liner
27—Engine cover
28—Exhaust valve
29—Having housing free piston rod
30—Having cog rail piston rod
31—Exhaust stroke a pair of half cog wheel
32—Working stroke a pair of half cog wheel
33—Suction stroke a pair of half cog wheel
34—Compression stroke a pair of half cog wheel
35—Having cog rail compression piston rod
36—Compression liner
37—Compression piston
38—Suction valve
39—Slider transfer valve
40—Fuel nozzle

The engine have been projected for Brayton cycle. Main purpose is to get high compression pressure in the gas turbine in which to get high of its compression pressure is impossible because of metalurgic limit and every liquid or gas fuels is be able to burn free of promlems within a combustion engine.

Having one liner, having four stroke, classic a piston engine is divided two parts in such a way that working and exhaust stroke will be able to realize in one liner and; suction and compression stroke will be able to realize in another one liner. And both liner have been connected and got synchronous. To make synchronic is impossible two liners by using crank mechanism because its linear motion is changeable. Phase difference is available between syncronic working piston therefore linear motion must be constant for cycle synchronous. Therefore half cog wheel-cog rail transfer mechanism is used for to transform of the rotary motion to linear motion.

Operating of engine: FIG. 10 was given at the end of compression stroke and at the beginning constant working position. In this point; slider transfer valve (39) be opened and pressured air begins transferring in the working liner (26) and fuel nozzle (40) sprays fuel. Mixture is ignited by spark plug. Spark plug is not necessary working temperature limits of engine. It is put for to be fixed beginning burn point of the cycle. It is not shown on the figure. Diameter of working liner (26) is big than compression liner (36) at the ratio increase amount of constant pressure working at the end volume. In this engine; stroke length is constant and equal cog wheels are used. If increase of stroke length is not become problem, equal diameter liners are used and diameters of cog wheels are changed at the same ratio. This aplication is given same result. In this point; while 34 number half cog wheels were pushing compression piston (37) to up, 32 number half cog wheels begin take constant pressure out put working of working stroke. When the compression piston (37) came at up point, constant pressure working of working stroke finished. Slider transfer valve (39) be closed. While gas mixture is beginning expansion polytropic suction valve (38) be opened and compression piston (37) begins the suction stroke. 34 number half cog wheels no longer be in use and 33 number half cog wheels be put into use.

Engine have been designed according to max. out put power and ambience pressure exhaust outlet. When the power of engine became less, exhaust pressure becomes less vacuum. Rod of working piston (25) is made having housing and rod of cog rail (30) is made be able to move within this housing for to obstruct vacuum. As working piston (25) was working, it is contact with cog rail (30). When the pressure became ambient, working piston (25) stops but cog rail lasts motion to down. When the 32 number half cog wheels no longer been in use, and 31 number half cog wheels be put into use, exhaust valve (28) be opened. When the cog rail (30) contacted on the working piston (25) rod, exhaust stroke begins.

Theoric thermic yield of engine is 0.76 for 160 atm max. pressure and 2800° K max. temperature. In the practice; having feedback Brayton cycle is used according to using purpose in which this cycle have been projected for to decrease to min engine's exhaust loss. Theoric yield of this cycle is 0.86 for same limits. 0.04 deviation is exist from Carnot yield. Cycle loss of this engine is not available in the practice. Total loss is exhaust, cooling and friction.

Two mechanism was used in this engine each other complemental. Them advantages for combustion engine was given below.

1—Free piston mechanism: Main purpose is to make equal discharge the pressure of Brayton cycle to ambience pressure. Same mechanism may be aplicated all of classic combustion engines and heat energy of having pressure exhaust gas may be transformed to mechanic energy. Advantages of this mechanism than turbocharging mechanism; it transforms all of useable exhaust heat energy to mechanic energy and its construction is too very simple. Best turbocharging unit can transform twentyfive percent of useable exhaust heat energy and its construction is very complex and sensitive. Main purpose of turbocharger is got high power. Free piston mechanism only obstruct exhaust loss. This mechanism was used in the prototype steam engine to obstruct exhaust pressure losses.
2—Half cog wheel-cog rail transfer mechanism: There are three important special features making important this mechanism. Linear speed of mechanism is constant. Length and speed of stroke may be changed for every stroke one by one by making modulation of cog wheel teeth and by changing diameter of cog wheel. Mechanism may be produced by using cheap standard simple parts and taking maintenance quickly. Advantages for combustion engine: It ensures synchronization of two pistons with a phase difference. Synchronic motion ensures able to be burned every fuel lquid or gas free of problems enough min. amount in the engine. For example; while a classic engine is running on no load, fuel be given of it is equal to ratio min. air-fuel in such a way that burnning will be able to realize is amount. This amount is too much than amount able to continue of engine motion. To give is enough on amount able to overcome friction only in this engine. Because combustion is continuous and partly. Being continuous of combustion system ensures using every kind of fuel used for gas turbine no depend on octane and cetane number also it ensures being constant of the thermic yield for partly loads practical. Because entering pressed air to system after from combustion is passive position and constant pressure working is done at the max. temperature therefore engine don't much be affected from the point of wiew thermic yield. Cooling loss of diesel engine is big than otto engine because its revulation is too less than otto engine. Speed of piston in the crank mechanism is too less about up point therefore mechanism is more suitable for otto engine. When the subject been diesel engine, burning speed of fuel and revulation of engine is very important. In the practice; revulation of quick a diesel engine is 2700 rpm and this value is half of normal otto engine's revulation and it is ¼ of quick otto engine's revulation. Revulation is got up be desired value for combustion is be free no problem in this engine. Cycle exhaust loss of a constant pressure cycle is to less than otto cycle. For this reason: cooling loss is done min. by combustion system and by increasing revulation. Ensuring this advantages is shaft mechanism indirectly the engine. If syncronic motion is not ensure, to be formed is impossible mechanism depend on combustion system. The mechanism may be used for to run a diesel engine in such a way that it will about use the Brayton cycle. Dead volume and exhaust pressure loss may be equal to zero in the diesel cycle, because to adjust the mechanism's speed and its stroke length is possible. Getting high pressure is too less because piston speed is constant and it is max. of cranck mechanism. Mechanism was used for steam engine and electric dynamo. The symmetric pair shaft mechanism have been used in the described engine and in the scope of project devices.

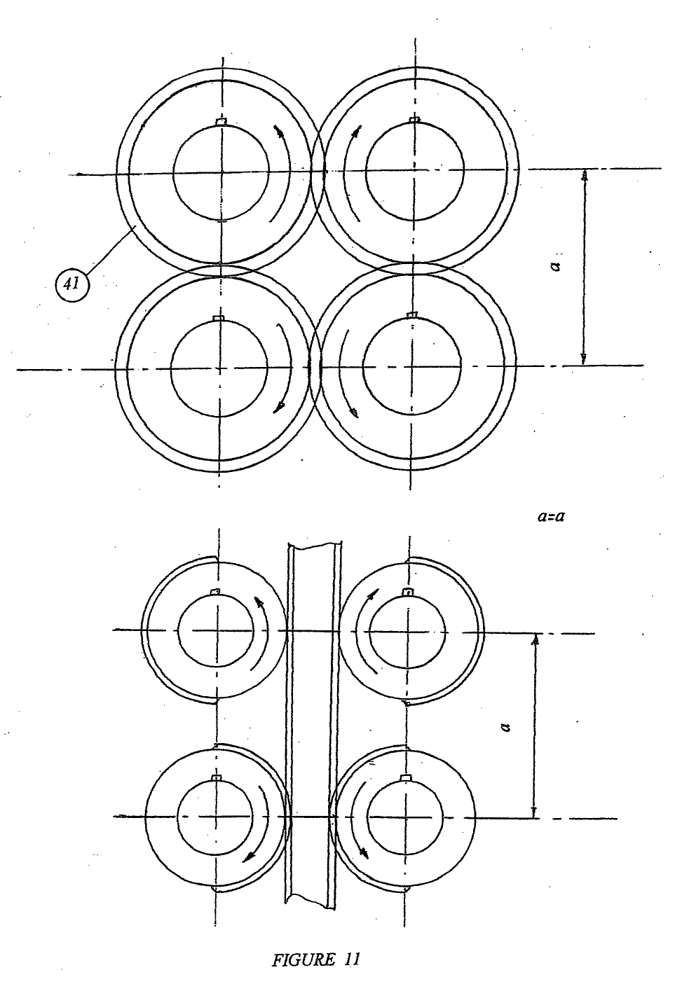

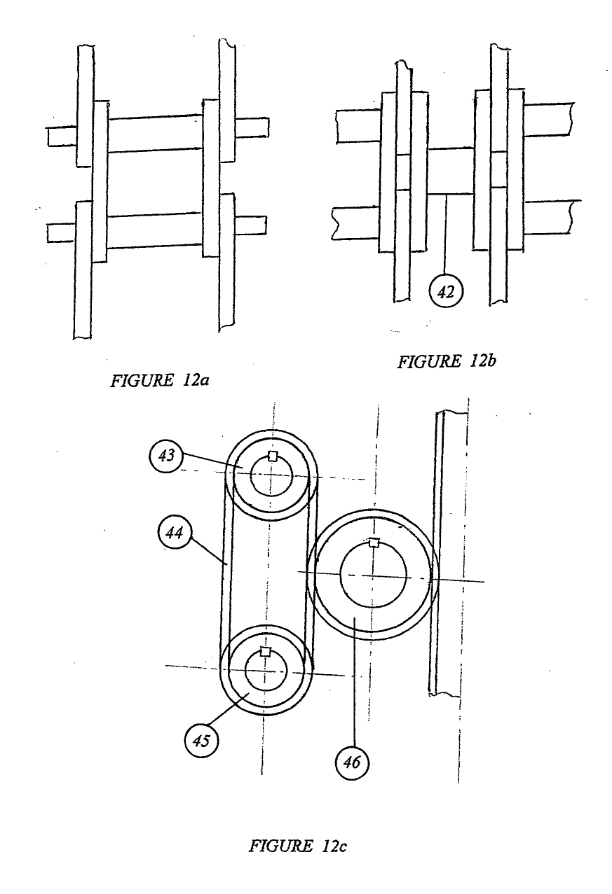

Shaft mounting plan of half cog wheel-cog rail mechanism was given FIG. 11. 41 number cog wheel is main shaft out-put transmission gear. Other touching cog wheels are equal diameter and its shafts are free. Classic Gall chain was given FIG. 12a and modified Gall chain was given FIG. 12b. Aplication plan of mechanism by using modified Gall chain for long stroke and high power was given FIG. 12c. Modified Gall chain is constructed by placing of given modulation interval Gall chain between two symmetric classic Gall chain. This part does same working of half cog wheel. 42 number part is modification cylinder. In the aplication FIG. 12c; 43 number cog wheel is main-auxiliary shaft transfer gear. Shafts of 45 and 46 number cog wheels are free. Teeth of midlle of 43 and 45 number cog wheels are cut from bottom of teeth where it is opposite side of modulated part of modified Gall chain. Wideness of 46 number cog wheel is equal wideness of modulated part of modified Gall chain and it is contact only on the modulated part.

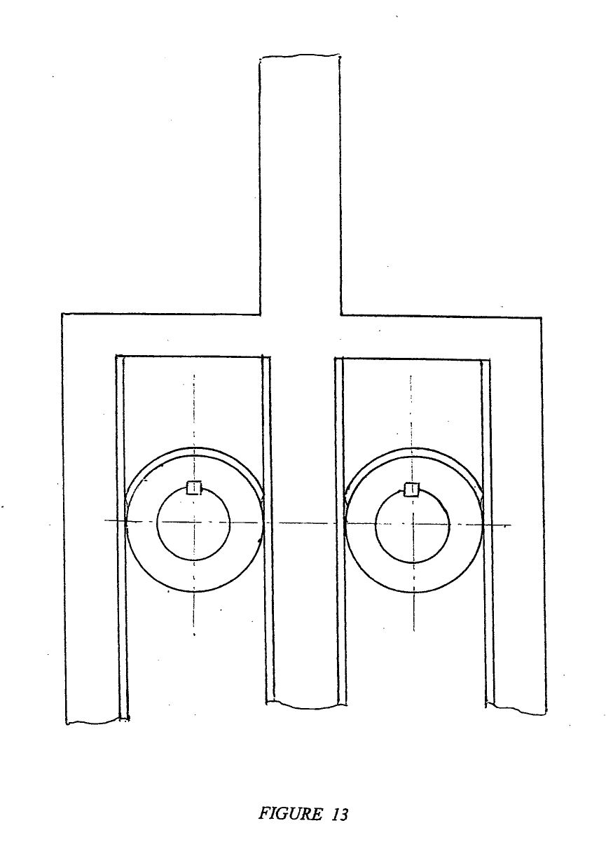

Aplication of mechanism for short stroke engine was given FIG. 13 by using symmetric two half cog wheels. In this aplication; number of cutting tooth is more than half. Decreased stroke length is equal half length of drawed chord from touch point of cog rail with cut cog wheel.

### Prototype Changeable Stroke Polyptropic Steam Engine

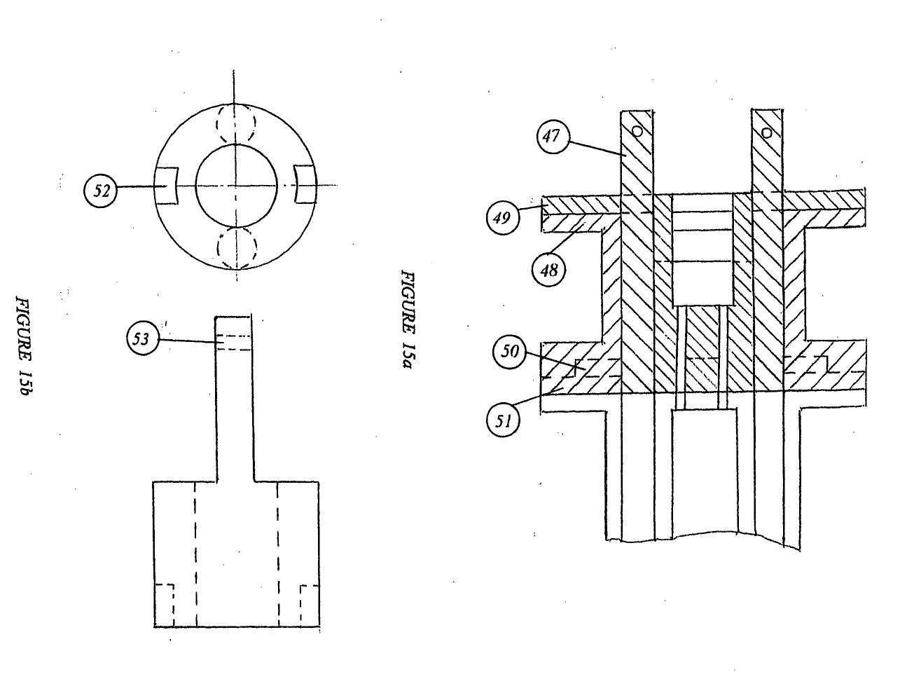

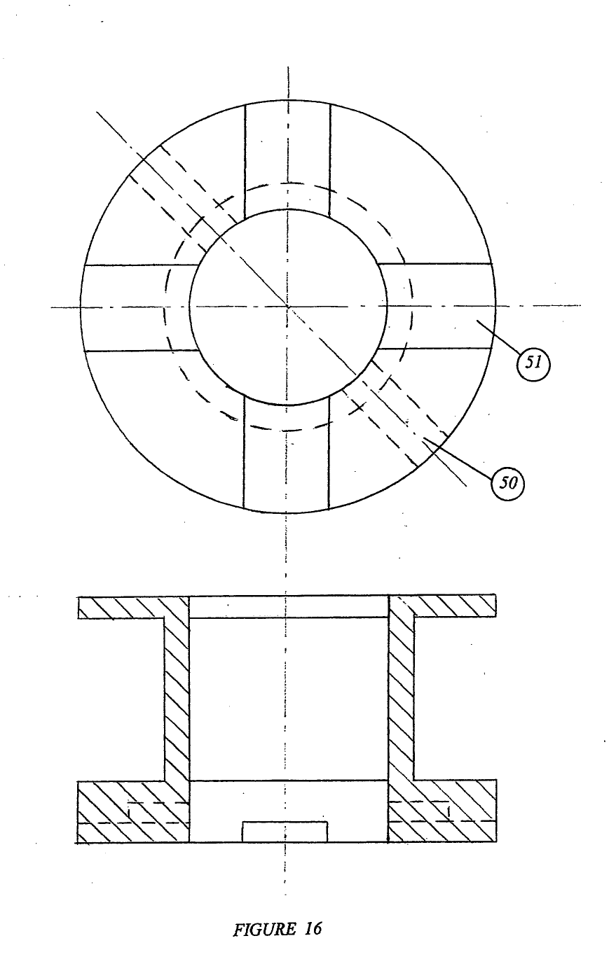

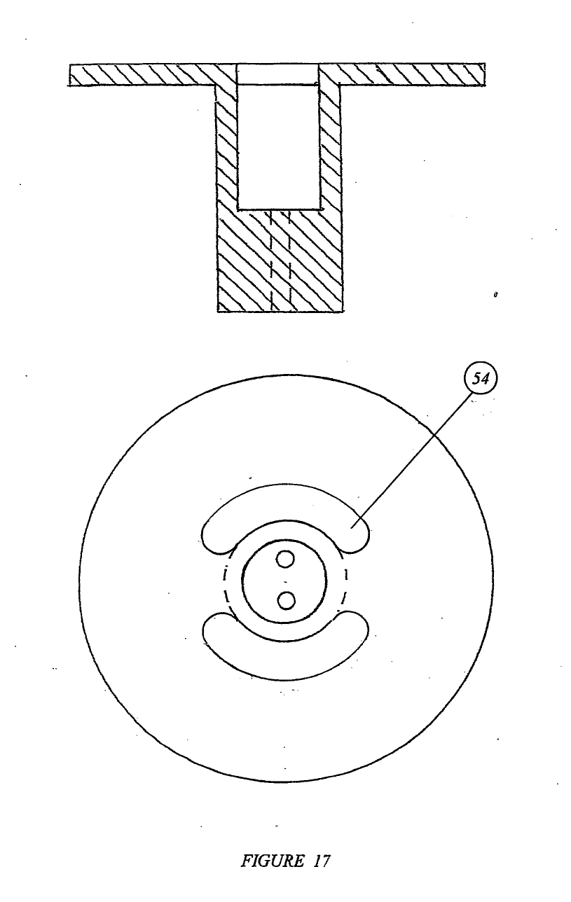

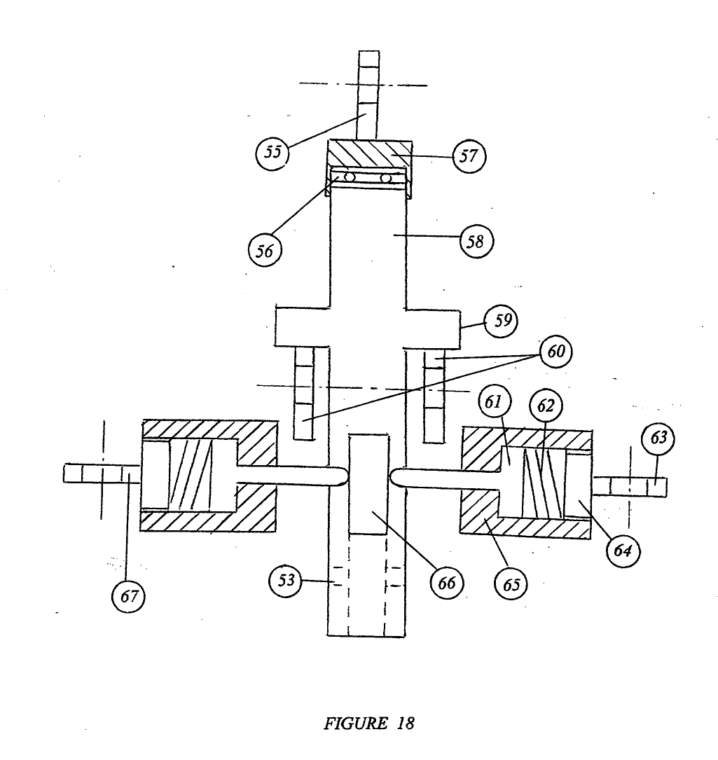

Working liner of synchronic engine was used to construct this engine. Forms of working piston and working liner have been changed for to increase heat transfer surface and a having rotary piston port controlled delivery-exhaust valve was placed in the engine. Working piston was given FIG. 14a and working liner was given FIG. 14b. Working piston is a piece of thick pipe as shown FIG. 14a. Working liner is heated from outer surface, and also from inner suface by holes its upside by using a heat transfer fluid. Main purpose is to obstruct become wet of expanded vapor and power is to increase. In the result heat of atmosphere is used for heating and there is its positive affect on the system. Having rotary piston port controled delivery-exhaust valve mounting drawings was given FIG. 15a. On the figure; 47 number part is valve piston. 48 number part is valve liner. 49 number part is core of valve liner. 50 number canal is delivery port. 51 number canal is exhaust port. Look from front and under drawings of rotary valve piston was given FIG. 15b. On the figure; 52 number canal is delivery canal and 53 number hole is driving mechanism joining pin hole. Look from front and under drawings of valve liner (48) was given FIG. 16. On the figure; 51 number bottom canals are exhaust ports and 50 number deviated 45° up canals are delivery ports. Look from front and up drawings of valve liner core (49) was given FIG. 17. On the figure; 54 number canals are outlet canals of valve piston rods and small holes midle of the valve liner core are heat transfer line holes. Diriving mechanism of having rotary piston port controlled delivery-exhaust valve mounting drawings was given FIG. 18. On the figure; 53 number hole is valve piston joining pin hole. 55 number part is exhaust port shutting cam. 56 number part is thrust ball bearing. 57 number part is ball bearing cover. 58 number part is valve piston pusher bar. 59 number part is lifting projection part. 60 number parts are lifting cams. 61 number part is delivery port opening pusher bar or turning pusher bar. 62 number part is spring. 63 number part is delivery port opening cam. 64 number part is cover. 65 number part is body of delivery port turning pusher bar. 66 number part is turning projection part. 67 number part is delivery port shutting cam. Turning cams were drawed symmetrical for be neutral position in this point.

### Operating of Driving Mechanism:

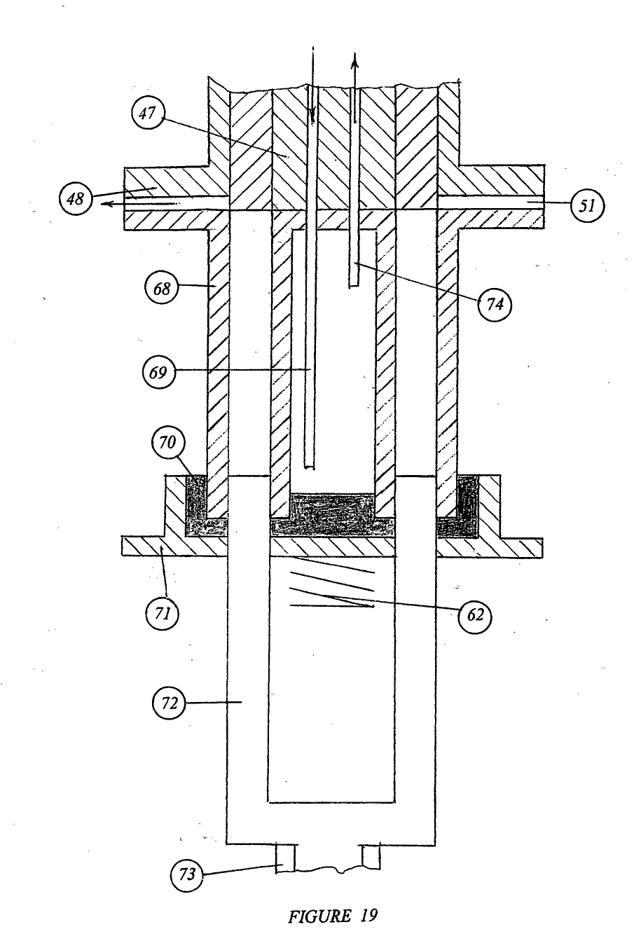

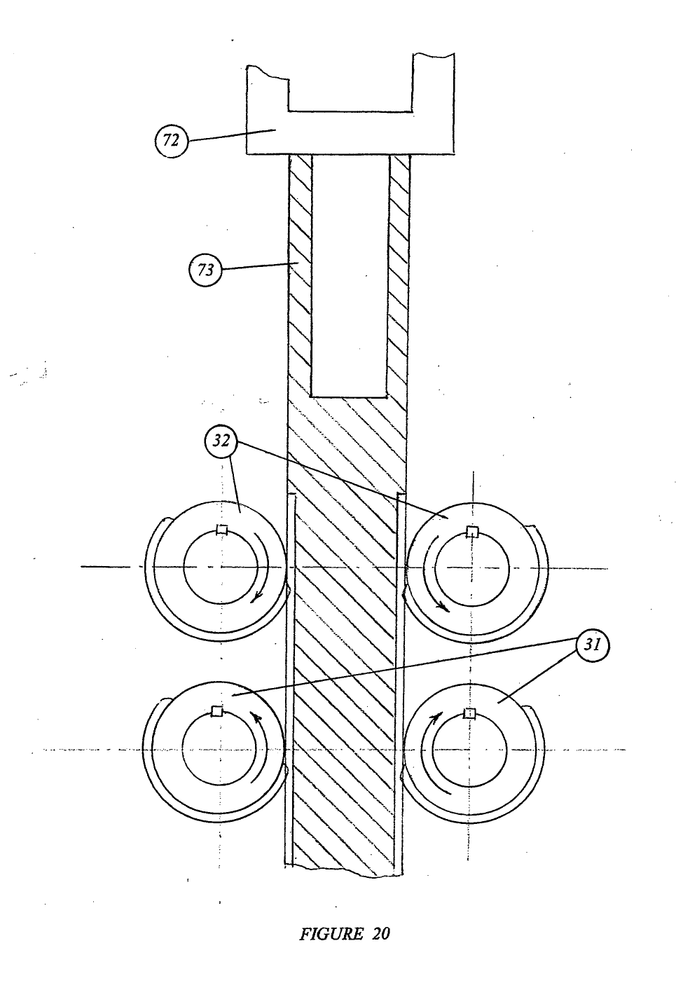

FIG. 18 was drawn while exhaust stroke was beginning. In this point; 55 and 60 number cams lift the valve piston pusher bar (58) to up by turning synchronic and exhaust ports (51) be opened. 63 number cam opens delivery ports (50) by turning 45° the valve piston pusher bar (58) in the ending point of exhaust stroke and 55-60 number cams take to below the valve piston pusher bar (58) by turning synchronic again that exhaust ports (51) be closed. Turning of valve piston pusher bar must be finished before down motion don't begin. If there is not pressure in working liner (68), turning of valve piston pusher bar is get difficult. When the costant pressure working finished, 67 number cam shuts delivery ports (50) by turnning to opposite the valve piston pusher bar (58). In this position; turning is free of problems, while valve piston (47) is being pushed to up by pressure, right force balances by thrust ball bearing (56). Mounting drawings of changeable stroke polyptropic steam engine have been given FIGS. 19 and 20 in such a way that its valve unit will stay at outside. On the FIG. 19; 68 number part is working liner. 69 number part is heat transfer fluid inlet pipe. 70 number part is stuffin-box packing type graphite liner-ring. (it isn't piston ring) 71 number part is liner bottom cover. 72 number part is working piston. 73 number part is having housing cog rail. 62 number part is spring. 74 number part is heat transfer fluid outlet pipe. On the FIG. 20; 32 number half cog wheels are working stroke cog wheels. 31 number half cog wheels are exhaust stroke cog wheels. A spring was put in the ending of cog rail for to obstruct tooth strike. On the figure was not shown. 73 number part is not same with 30 number cog rail given FIG. 10. Hausing was drilled in the cog rail rod this engine but hausing is within the piston rod in the free piston mechanism for syncronic engine.

### Prototype Solenoid Engine-Dynamo

Purposes are to produce high power in the small volume without vibration constant current. For electric energy is being produced at electric power plants and it is being distributed from this plant to using persons, electric industry had developed and got standard according to production technique. Within the scope this project; being stored is necessary produced of mechanic energy productivily. To make this work is very expensive and it is suitable for partly using by accumulator. To store be needed the energy by being transformed to the hydrogene for kitchen and mobil usng. There is necessity productive and powerful having low voltage a accouplement dynamo-engine for this work.

Solenoid engine-dynamo is electric engine, without brush, having constant current, operating reversible engine or dynamo so that it is not necessitate any adjust for this work. It was projected for electrolysis plant and electric car engine. It is also suitable for universal using. Its different from a classic electric engine; its of motion is be alternative linear and this of motion is be transformed to rotary motion by using half cog wheel-cog rail mechanism. It contains right placed a solenoid coil between two same magnetic poles or two opposite coiled solenoid coils.

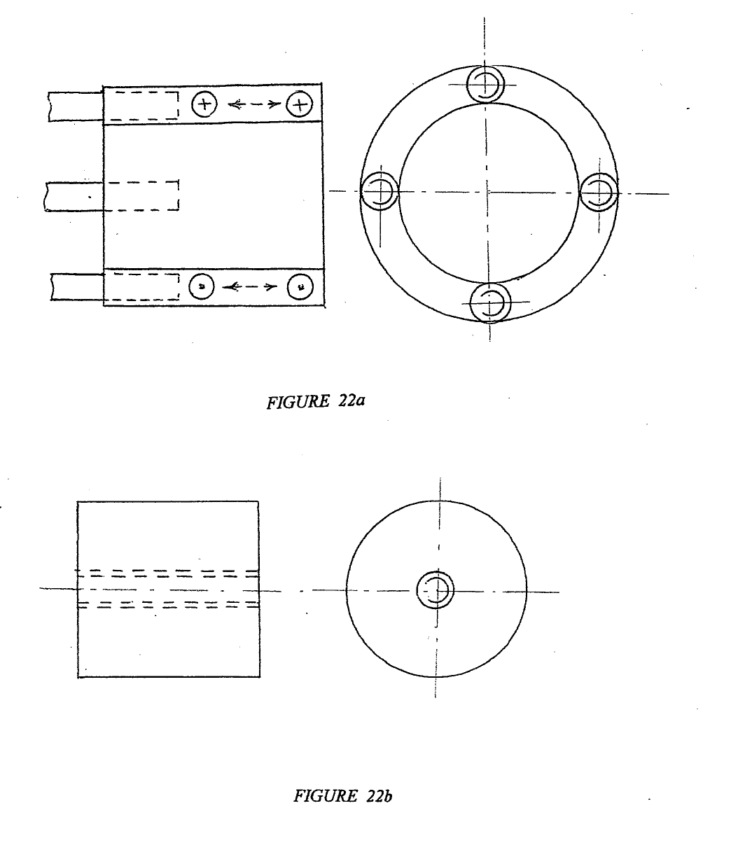

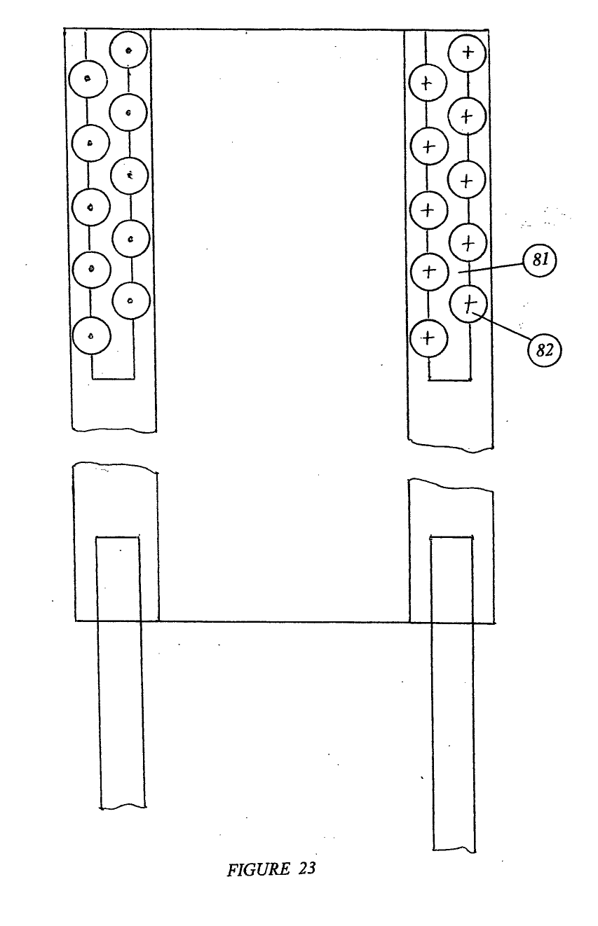

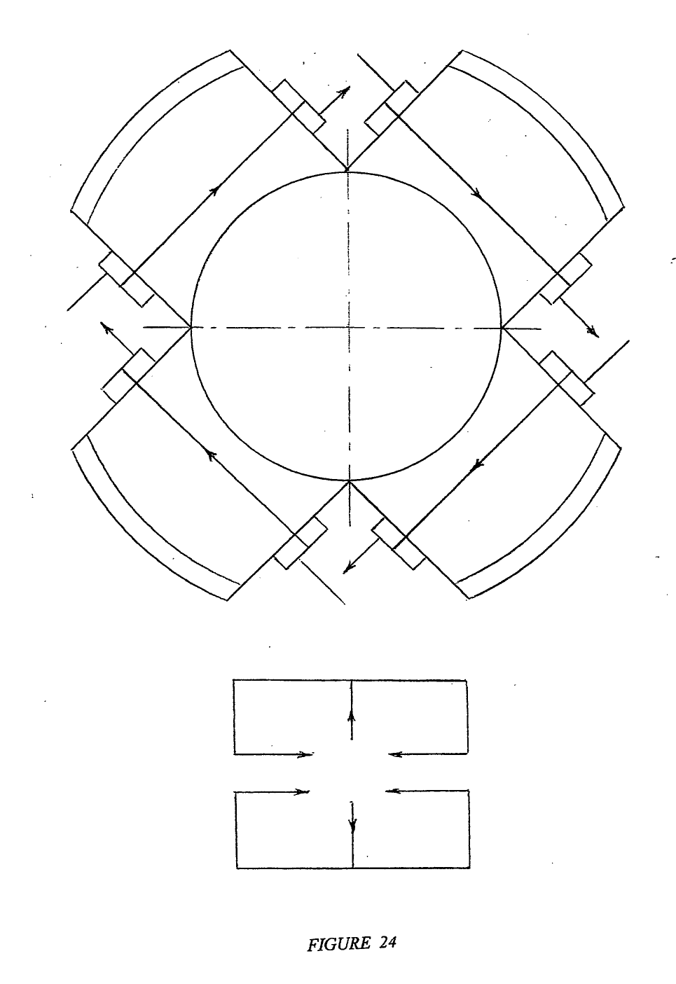

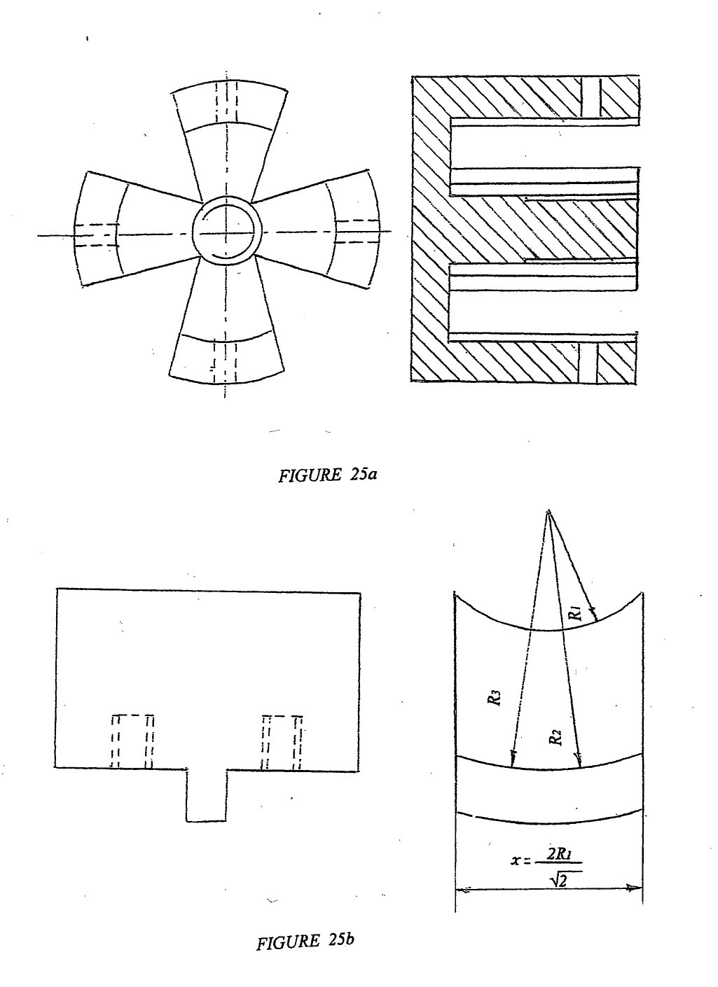

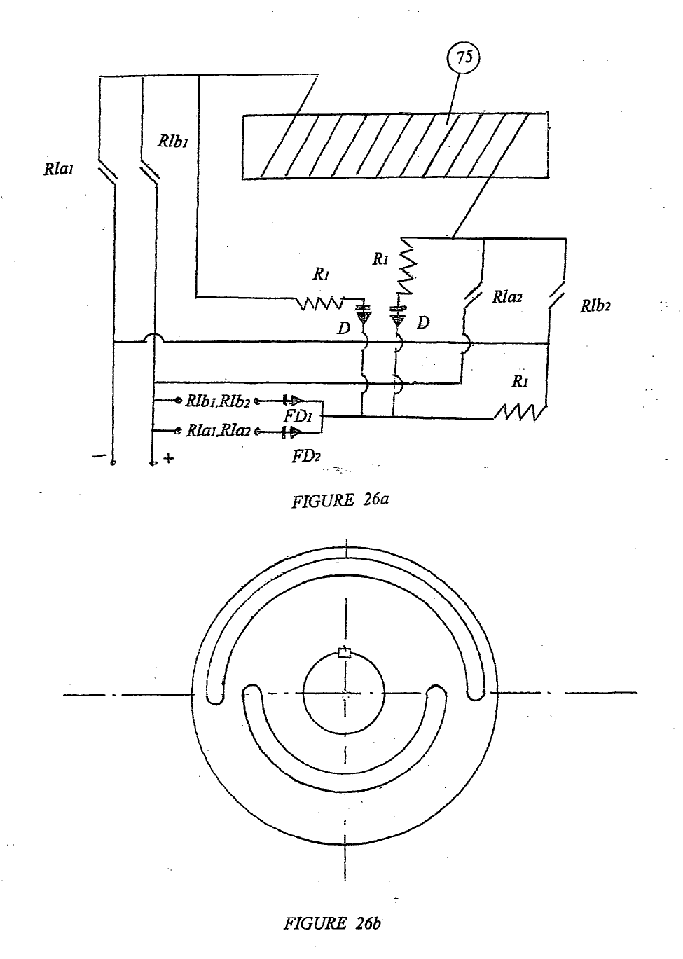

Mounting drawings of engine was given FIG. 21. On the figure: 75 number part is induced solenoid coil. 76 number part is inductor unit. 77 number part is S-N magnetic pole core. 78 number part is inductor unit up cover. 79 number part is inductor unit bottom cover. 80 number part is inductor unit feeding auxilary solenoid coil. Look from front and up drawings of induced coil (75) for small power and normal current was given FIG. 22a. It is solenoid coiled by using thick wire. Coil had been got strengthen with nylon textile fibers and after symmetrical joining metal bars were placed its upside it had been taken within the hard plastic casting melting high temperature thermo or thermoset in the a piece of pipe form. After its surfaces were buffed. Phenol-form aldehyde, nylon, polycapro-lactam, polymethylmetacrylate, galalithe, melamine may be used for plastic. Joining metal bars are placed in such a way that they will be outside of magnetic field in which they must be nonmagnetic materials. (may be austenitic steel, 18CrNi8 alloy) Induced coil (75) is joined up of engine case and it is motionless part as shown FIG. 21. Induced coil (75) for high power drawings was given FIG. 23. (Not hatched for not mix figure) Solenoid coil is coiled by using a copper pipe (82) and a heat transfer fluid passes from within the pipe continue. This induced coil is used for to produce electric current and it is also used being coiled cooling pipe. Copper pipe (82) is filled with sand or having high boiling point a hydraulic fluid and its mouths are closed by plugging. Copper pipe is coiled on the helical mold by heating or at cold with same shape of in surface helical coil former (81). Coiled pipe is removed by turning from on the mold and after it is placed by turning inner surface of helical coil former (81). Left over straight pipe is coiled on the out shape of helical coil former. Mouths of pipe are opened and materials in of pipe are discharged. Prepared part is taken into having glass or asbestos filling up plastic casting and its surface is buffed. Induced coil (75) for high power is joined up case of engine and bottom case of engine by using symmetrical nonmagnetic joining bars. Tensile is only right direction compress on the coil unit. Cooling is done with transformer oil by cooling pump. Inductor coils (76) have been formed of solenoid coils in which they are coils, coiled same direction and they are placed on a circle in such a way that same poles will be able to look to circle center. Look from up mounting drawings of inductor (76) coils and occurred magnetic field lines depend on it were given FIG. 24. Look from front and up drawings of single inductor coil core were given FIG. 25b. Inductor (76) coil cores are joined by using bolt on inductor up cover (78) and bottom cover (79). Look from front and under drawings of inductor up cover were given FIG. 25a and bottom cover is same its but drilled holes on its are different. It is screwed middle of covers (78-79) and S-N magnetic coil cores (77) are screwed on them in which they is complementary of magnetic circuit. Look from front and up of S-N magnetic coil cores were given FIG. 22b. Prepared having closed magnetic circuit inductor unit (76-77-78-79) is moving part of engine-dynamo. Constant and uniform a magnetic field is occurred to direction from outside to cylinder circles center, in the wideness of poles by this form. Covers (78-79) close the magnetic circuit. Induced coil (75) wires are cut by right angle magnetic vectors on every point at moving time. If a current is given induced coil (75) of device, inductor unit (76-77-78-79) move to up or down according to E=Blv, F=BIl depend on direction of inductor (76) current for induced coil (75) is fixed. Direction of electric current has to be changed periodical for continuously motion. To use is impossible commutator-brush system. Engine was projected for high current. (3000-5000 A) To rectify is impossible the monophase current for this values with available technique. To rectify is possible the becoming square wave by using classic bridge diode for small power but device may be used only being dynamo. Peroidical change of current is realized by using Reed relay magnetic commutator in which it is controlled laser photo-diode control system. Electronic circuit was given FIG. 26a. Electronic circuit is controlled by laser photo-diode shaft modifier disc given FIG. 26b. There are two having hole canals on its on which they are half tour on two different orbits. Disc is placed on the shaft of engine. A photo-diode (FD₁-FD₂) is placed behind of every hole canal with interval 180° angle. A led laser is placed opposite of every hole canal front side of disc.

Operating for engine: Two led laser light continuously. If FD₁ foto-diode is be put into use, current passes through (R₃-Rlb₁-Rlb₂) reed relay electromagnetic circuit and relays be closed. When the FD₂ photo-diode been put into use, current passes through (R₃-Rla₁-Rla₂) reed relay electromagnetic circuit. Direction of induced coil (75) current changes.

Operating for dynamo: If device is operating with a accumulator battery accouplement, separate a circuit no need. But if accouplement accumulator battery is nonexistent, current is not available into of relays for they be open and led lasers are not light. Therefore connection is done from induced coil to led laser circuit by using normal diode and resistance. (R₁-D₂ and R₂-D₁)

Feeding of inductor coils (76) are done by using auxilary selonoid coil (80). Auxilary solenoid (80) is placed on inductor bottom cover and it moves within auxilary inductor unit. Auxilary inductor unit is prepared by using naturel magnet and it is small model of main inductor unit (76-77-78-79). Becoming square alternative current into auxilary selonoid coil is given to inductor coils (76) by rectifying through a classic rectifier. Inductor unit (76-77-78-79) is connected on the half cog wheel-cog rail mechanism by rod of cog rail (35). Using half cog wheel-cog rail mechanism is give reversible operating feature the engine. If crank mechanism is used, device operates for direct current engine but it doesn't operate for dynamo. Because linear speed of mechanism have to be constant for constant current. Becoming current is classic sinusoidal alternative current by crank mechanism.

There are two using purposes of engine-diynamo. First purpose is to supply the electric current having low voltage and high current without vibration for electrolysis units. Second purpose is car electric engine. Power need of a car is between 12-20 KW for 90 km/h in the normal road conditions. Max. power is necessary five multiple of normal power for a car according to road conditions for short interval. To load is impossible five mutiple even for short time the classic electric engine projected for normal power. Therefore a classic car engine is constructed for max. power. Engine-dynamo is constructed for normal power because there is circulating cooling system of it and it is suitable for changeable load. To adjust is possible without limit power and speed by changing current or voltage. But to change is impossible running direction of engine. Direction shift gear is necessary for shaft mechanism. Power of engine is bigger fourty percent than equal classic engine. Foucalt and hysteresis losses don't occur for used constant magnetic field and its is advantage this feature according to classic engine.

1. It is thermodynamics continuous cycle machine constituted by using absorber, evaporator, separator units, operating in accordance with thermodynamics absorbtion cooling cycle and its special feature is the fact that it comprises thermochemical separation process technique, active chemical separation process technique, changeable stroke polyptropic steam engine and solenoid engine-dynamo.

2. It is the changeable stroke polyptropic steam engine as recited in claim 1 and its special feature is the fact that it includes a free piston motion mechanism moving in having housing cog rail.

3. It is free piston motion mechanism as recited in claim 2 and its special feature is the fact that its stroke length is changeable according to output power.

4. It is changeable stroke polyptropic steam engine as recited in claim 1; and its special feature is the fact that it includes rotary-linear motion transfer mechanism in which it have two pair of half cog wheels having move to up-down the cog rail.

5. It is changeable stroke polyptropic steam engine as recited in claim 1 and its special feature is the fact that it includes polyptropic liner.

6. It is polyptropic liner as recited in claim 5 and its special feature is the fact that it comprises of combination of two interlaced cylinders with enlarged heat transfer surface.

7. It is solenoid engine-dynamo as recited in claim 1 and its special feature is the fact that it includes having circulation cooling solenoid coil coiled by using copper pipe.

8. It is solenoid engine-dynamo as recited in claim 1 and its special feature is the fact that it includes rotary-linear motion transfer mechanism in which it have two pair of half cog wheels having move to up-down the cog rail.

9. It is rotary-linear motion transfer mechanism as recited in claim 4 and its special feature is the fact that rotary speed is equal to linear speed.

10. It is rotary-linear motion transfer mechanism as recited in claim 4 and its special feature is the fact that length and speed of linear motion may be changed to up and down by changing diameters of half cog wheels or them tooth number.

11. It is thermochemical separation process technique as recited in claim 1 and its special feature is the fact that it includes
A+B←→<→AB homogeneous absorbtion reaction
AB+C→BC+A homogeneous-heterogeneous phase separation reaction
BC→B+C thermic decomposition reaction chemical operation steps.

12. It is thermochemical separation process technique as recited in claim 1, and its special feature is the fact that reaction heat of homogeneous reaction is bigger than reaction heat of decomposition reaction.

13. It is active chemical separation process technique as recited in claim 1 and its special feature is the fact that it includes
AB+C→BC+A homogeneous-heterogeneous solid-liquid phase contact reaction
BC+A→AB+C homogeneous-heterogeneous gas-liquid phase contact reaction chemical operation steps.

14. It is active chemical separation process technique as recited in claim 1 and its special feature is the fact that activite of B is opposite direction on the phase limits solid-liquid and gas-liquid.
